(19) United States
(12) Patent Application Publication
(10) Pub. No.: US 2026/0124683 A1
(43) Pub. Date: May 7, 2026

(54) CHUCK WITH QUICK CONNECT SPINDLE INTERFACE

(71) Applicants: Apex Brands, Inc., Apex, NC (US); Jacobs Chuck Manufacturing (Suzhou) Company LTD., Suzhou (CN)

(72) Inventors: Jichun Zhou, Suzhou (CN); Tingwei Zeng, Suzhou (CN); Michael Goodson, Belton, SC (US)

(21) Appl. No.: 19/480,566

(22) PCT Filed: May 15, 2023
(86) PCT No.: PCT/CN2023/094129

§ 371 Date: Oct. 31, 2025

(51) Int. Cl. B23B 31/12; B23B 45/00

(52) U.S. Cl. CPC B23B 31/12; B23B 45/00

(57) ABSTRACT

A chuck includes a detent member (54) and a collar (50). The detent member (54) is movable to secure the drive spindle. The collar (50) is axially movable into a spindle disengaged position and a spindle engaged position. A collar spring (55) may apply a collar spring bias on the collar (50). A separation spring assembly (60) may apply a separation bias on the drive spindle. When the collar (50) is in the spindle disengaged position, the detent member (54) may be at least partially disposed within a collar recess and both the collar (50) and the separation spring assembly (60) may apply bias forces on the detent member (54). When the collar (50) is in the spindle engaged position, the detent member (54) is moved out of the collar recess and onto an engaging surface of the collar (50) to inhibit radial movement of the detent member (54). The chuck can reduce the time to remove and install the chuck onto a rotating power tool.

### TECHNICAL FIELD

Example embodiments generally relate to chucks for use with power drivers including power drills, and more particularly, relate to technology for a chuck coupling interface.

### BACKGROUND

A rotating power tools have been developed that offer the flexibility of attaching different working ends to the power tool based on the task to be performed. A chuck for securing a drill bit or fastener bit to the rotating power tool may be one example of a working end that may be attached to a rotating tool. In this regard, due to the wide variety of sizes and types of bits, in some working environments it may be necessary to use different chucks (e.g., chucks for large diameter bits, chuck for small diameter bit, chucks with specific bit interface features for specialized bits, etc.) with the same rotating power tool. For example, in a manufacturing assembly line environment, an assembler may need to change working ends on a rotating power tool during a same stage of product assembly.

The removal and replacement of a working end, such as a chuck, can be a time consuming process. In situations such as assembly line manufacturing, the delays associated with working end replace can slow assembly and negatively impact product assembly times and manufacturing yields. As such, it would be beneficial to develop improve chucks that minimize the time associated with removing and installing the chuck onto a rotating power tool, but are also securely coupled when performing a task.

### SUMMARY OF SOME EXAMPLES

According to some example embodiments, a chuck for use with a rotating power tool having a drive spindle is provided. The chuck may comprise a plurality of jaws configured to open or close to install or remove a bit, and a body assembly comprising a spindle cavity configured to receive the drive spindle. The body assembly may also be configured to translate rotation of the drive spindle about a center axis of the chuck to the plurality of jaws to rotate the bit. The chuck may also comprise a detent member that may be moveable relative to the body assembly. The detent member may be movable to engage with the drive spindle to secure the drive spindle to the chuck and disengage from the drive spindle to permit removal of the drive spindle from the chuck. The chuck may also comprise a collar comprising a collar recess and a collar engaging surface. The collar may be axially movable relative to the body assembly and the detent member into a spindle disengaged position and a spindle engaged position. Further, the chuck may comprise a collar spring operably coupled to the collar to apply a collar spring bias on the collar, and a separation spring assembly disposed within the spindle cavity and configured to apply a separation bias on the drive spindle when the separation spring assembly is engaged with the drive spindle within the spindle cavity. When the collar is in the spindle disengaged position and the detent member is not engaged with the drive spindle, the detent member may be at least partially disposed within the collar recess and both the collar and the separation spring assembly may apply bias forces on the detent member. When the collar is in the spindle engaged position and detent member is engaged with the drive spindle, the detent member may move out of the collar recess and onto the collar engaging surface to inhibit radial movement of the detent member.

According to some example embodiments, another chuck for use with a rotating power tool having a drive spindle is provided. The chuck may comprise a plurality of jaws configured to open or close to install or remove a bit, a body assembly being configured to translate rotation of the drive spindle about a center axis of the chuck to the plurality of jaws, a detent member movable to engage with the drive spindle to secure the drive spindle to the chuck and disengage from the drive spindle to permit removal of the drive spindle from the chuck, and a collar comprising a collar recess. The collar may be axially movable relative to the body assembly into a spindle disengaged position and a spindle engaged position. The chuck may also comprise a collar spring operably coupled to the collar to apply a collar spring bias on the collar, and a separation spring assembly operably coupled to the body assembly and configured to apply a separation bias on the drive spindle when the separation spring assembly is engaged with the drive spindle. When the collar is in the spindle disengaged position and the detent member is not engaged with the drive spindle, the detent member may be at least partially disposed within the collar recess and both the collar and the separation spring assembly may apply bias forces on the detent member. When the collar is in the spindle engaged position and detent member is engaged with the drive spindle, the detent member may be moved out of the collar recess.

According to some example embodiments, another chuck for use with a rotating power driver having a drive spindle is provided. The chuck may comprise a plurality of jaws configured to open or close to install or remove a bit. The jaws may be disposed at a forward end of the chuck. The chuck may further comprise a body assembly comprising a spindle cavity to receive the drive spindle at a rearward end of the chuck. The body assembly may be configured to translate rotation of the drive spindle about a center axis of the chuck to the plurality of jaws. The chuck may further comprise a detent member moveable relative to the body assembly. The detent member may be movable to engage with the drive spindle to secure the drive spindle to the chuck and disengage from the drive spindle to permit removal of the drive spindle from the chuck. The chuck may also comprise a collar comprising a collar recess and a collar engaging surface. The collar may be axially movable relative to the body assembly and the detent member into a spindle disengaged position and a spindle engaged position. The chuck may also comprise a collar spring operably coupled to the collar to apply a collar spring bias on the collar, and a separation spring assembly disposed within the spindle cavity and configured to apply a separation bias on the drive spindle when the separation spring assembly is engaged with the drive spindle within the spindle cavity. When the collar is in the spindle disengaged position and the detent member is not engaged with the drive spindle, the detent member may be at least partially disposed within the collar recess and the detent member may extend into the spindle cavity to operate as a stop for the separation spring assembly.

### BRIEF DESCRIPTION OF THE DRAWINGS

Having thus described some example embodiments in general terms, reference will now be made to the accompanying drawings, which are not necessarily drawn to scale, and wherein:

FIG. 1A illustrates a perspective side view of a chuck in accordance with some example embodiments;

FIG. 1B illustrates a front view of a chuck according to some example embodiments and defining cross-section plane A-A;

FIG. 1C illustrates an exploded view of a chuck according to some example embodiments;

FIG. 2A illustrates a perspective side view of a body assembly according to some example embodiments;

FIG. 2B illustrates a perspective rear view of the body assembly according to some example embodiments;

FIG. 3A illustrates a perspective rear view of a collar according to some example embodiments;

FIG. 3B illustrates a rear view of a collar according to some example embodiments and defining cross-section plane B-B;

FIG. 3C illustrates a cross-section side view of the collar according to some example embodiments, the cross-section side view being defined at B-B of FIG. 3B;

FIG. 3D illustrates a rear view of an internal collar according to some example embodiments and defining cross-section plane C-C;

FIG. 3E illustrates a cross-section side view of a shape of a portion of the internal collar according to some example embodiments, the cross-section side view being defined at C-C of FIG. 3D;

FIGS. 4A to 4C illustrate cross-section side views of a shape of a portion of the internal collar according to some example embodiments, the cross-section side views taken at C-C of FIG. 3D in various relative positions with the detent member according to some example embodiments;

FIG. 5 illustrates a detent spring according to some example embodiments;

FIG. 6 illustrates, according to some example embodiments, a cross-section side view of a shape of a portion of the internal collar defined at C-C of FIG. 3D;

FIG. 7A illustrates a forward view of a separation ring in accordance with some example embodiments and defining cross-section plane D-D;

FIG. 7B illustrates, according to some example embodiments, a cross-section side view of a separation ring defined at D-D of FIG. 7A;

FIG. 7C illustrates a perspective side view of a drive spindle according to some example embodiments;

FIG. 8A illustrates a cross-section side view taken at A-A of FIG. 1B of a chuck with a collar in a spindle disengaged position according to some example embodiments;

FIG. 8B illustrates a zoomed view of a boxed portion of the chuck of FIG. 8A according to some example embodiments;

FIG. 8C illustrates a cross-section side view taken at A-A of FIG. 1B of a chuck with a collar in a spindle transition position and a drive spindle entering a spindle cavity of the chuck according to some example embodiments;

FIG. 8D illustrates a zoomed view of a boxed portion of the chuck of FIG. 8C according to some example embodiments;

FIG. 8E illustrates a cross-section side view taken at A-A of FIG. 1B of a chuck with a collar in a spindle engaged position with the chuck according to some example embodiments;

FIG. 8F illustrates a zoomed view of a boxed portion of the chuck of FIG. 8E according to some example embodiments;

FIG. 8G illustrates a cross-section side view taken at A-A of FIG. 1B of a chuck with a collar in a spindle transition position and a drive spindle exiting a spindle cavity of the chuck according to some example embodiments;

FIG. 8H illustrates a zoomed view of a boxed portion of the chuck of FIG. 8G according to some example embodiments;

FIG. 9 illustrates a cross-section side view of another chuck according to some example embodiments, the cross-section side view taken at a plane similar to the plane defined by A-A of FIG. 1B with respect to the chuck of FIG. 1B;

FIG. 10 illustrates a cross-section side view of another chuck according to some example embodiments, the cross-section side view taken at a plane similar to the plane defined by A-A of FIG. 1B with respect to the chuck of FIG. 1B;

FIG. 11A illustrates a cross-section side view of another chuck according to some example embodiments, the cross-section side view taken at a plane similar to the plane defined by A-A of FIG. 1B with respect to the chuck of FIG. 1B;

FIG. 11B illustrates a zoomed view of a boxed portion of the chuck of FIG. 11A according to some example embodiments; and

FIGS. 12A to 12C illustrate cross-section side views of a shape of a portion of the internal collar of the chuck of FIG. 11A according to some example embodiments, the cross-section side views taken at a plane similar to the plane defined by C-C of FIG. 3D.

### DETAILED DESCRIPTION OF SOME EXAMPLE EMBODIMENTS

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. As used herein, operable coupling should be understood to relate to direct or indirect connection that, in either case, enables functional interconnection of components that are operably coupled to each other.

Example embodiments of a chuck are provided that can be quickly and intuitively secured to a drive spindle of the rotating power tool, and also quickly and intuitively removed from the drive spindle of the rotating power tool. In this regard, the chuck may comprise a quick connect spindle interface in support of such functionality. Such an example chuck may include movable jaws configured to clamp onto a removable bit to allow a variety of bits (e.g., drill bits, fastener bits, etc.) to be coupled to and driven by a rotating drive spindle of a rotating power tool. Some example embodiments leverage the operation of a movable collar of the chuck that provides a user interface to control disengaging operations. More specifically, according to some example embodiments, movement of the collar may cause responsive movement of a detent member that can engage with the drive spindle to secure the chuck to the drive spindle. Additionally, movement of the collar may also cause responsive movement of the detent member to disengage from the drive spindle to permit removal of the chuck from the drive spindle.

Further, according to some example embodiments, the collar may be subjected to a collar spring bias that facilitates a spring-latched detent engagement with drive spindle. In other words, according to some example embodiments, for installation, the chuck may simply be urged onto the drive spindle, without the user applying a targeted force onto the collar, and the spring bias may operate to perform a latching operation to secure the chuck to the spindle. According to some example embodiments, for removal of the chuck from the drive spindle, a user may move the collar to release the detent member and a separation spring assembly may operate to urge the chuck away from the drive spindle for a quick and convenient removal operation.

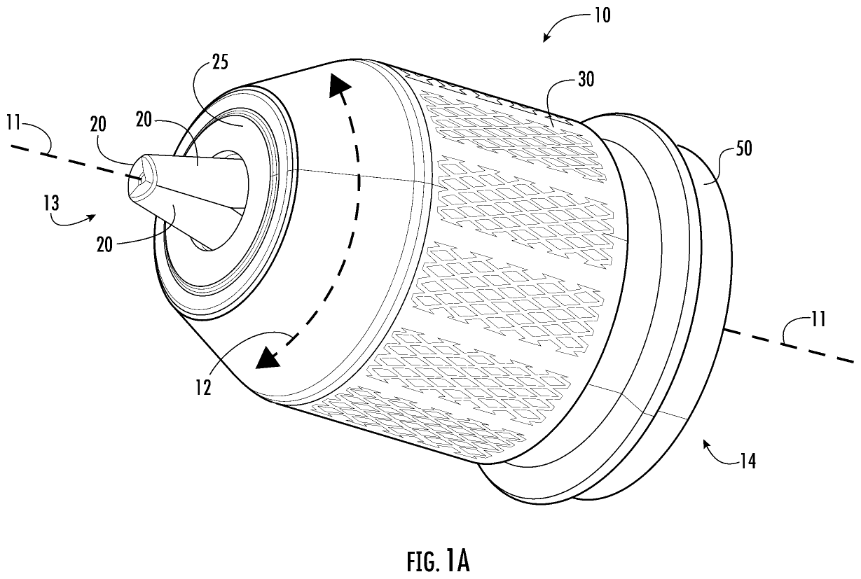

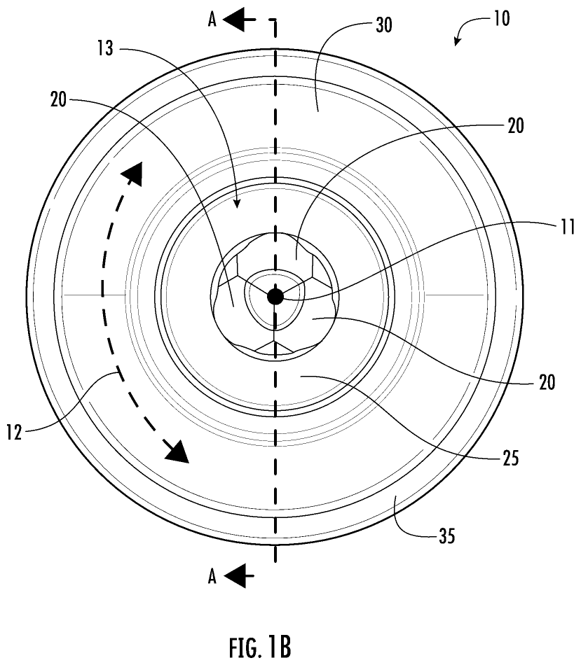

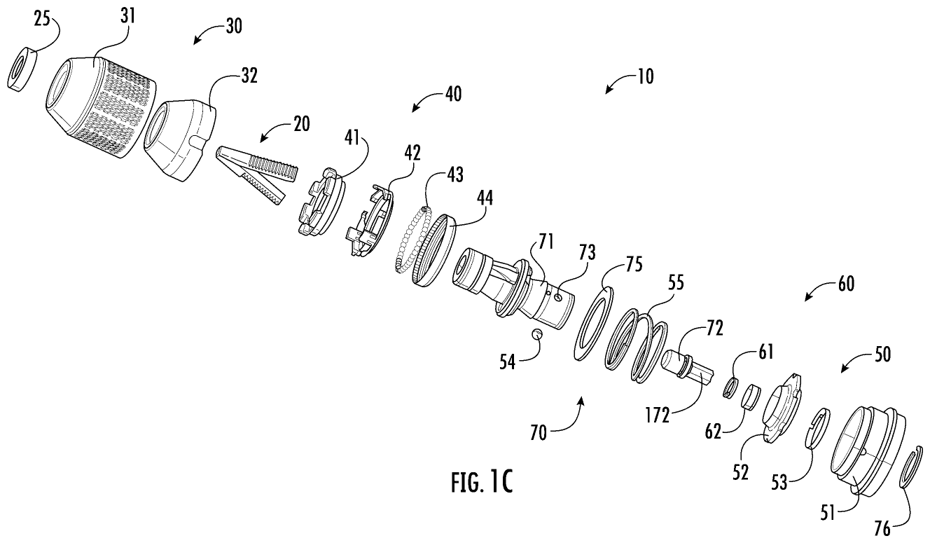

Having described some aspects of example embodiments, a more detailed description of some example embodiments will now be provided with reference to FIGS. 1A-12C. As such, referring to FIGS. 1A and 1B, which provide views of an example chuck 10 having a quick connect spindle interface according to some example embodiments. FIG. 1A is a perspective view of an example chuck 10, and FIG. 1B is a front view of the chuck 10.

Generally, the chuck 10 may operate to secure a working bit (not shown) in the jaws 20 of the chuck 10 to transfer the rotating of a drive spindle to the bit. The chuck 10 may also operate to permit working bits of varying sizes (e.g., diameters) to be installed and removed by moving the jaws 20 in an opening or closing direction via, for example, rotation of the sleeve 30 as indicated by the arrow 12. Further, the chuck 10 may be operably coupled with any type of rotating power tool that comprises a drive spindle, including, for example, a pneumatic or electric powered tool (e.g., a drill) configured to rotate the drive spindle that may be operably coupled to the chuck 10 at a back or rear end 14 of the chuck 10.

The chuck 10 may define a center axis 11, about which the chuck 10 may rotate with the drive spindle. For orientation purposes, the chuck 10 may have a forward end 13 and a rear end 14. The chuck 10 may comprise, among other components, jaws 20, a nose 25, a sleeve 30, and a collar 50. According to some example embodiments, the nose 25 and the jaws 20 may be disposed adjacent to the forward end 13, and the collar 50 may be disposed adjacent to the rear end 14. According to some example embodiments, the sleeve 30 may be disposed between the nose 25 and the collar 50. As further described herein, the jaws 20 may be configured to move or translate within passageways in a body of the chuck 10, which may be a component of a body assembly, in a closing or opening direction to change the size of a jaw opening formed by the forward ends of the jaws 20.

The sleeve 30 may operate as a user interface for opening and closing the jaws 20. According to some example embodiments, the sleeve 30 may be permitted to rotate to open or close the jaws 20. According to some example embodiments, the sleeve 30 may also be operably coupled to a nut that engages with the jaws 20 in, for example, a spiral-threaded manner to move the jaws 20 in the opening or closing direction based on the direction of rotation of the sleeve 30, as indicated by arrow 12. As such, rotation of the sleeve 30 may cause the jaws 20 to move such that the jaws 20 clamp onto a working bit or open to permit removal or installation of a working bit.

To better understand the components and operation of the chuck 10, FIG. 1C provides an exploded view of some of the various components of the chuck 10, according to some example embodiments. The chuck 10 may include various components including a sleeve 30, a bit interface assembly 40, a body assembly 70, a collar 50, and a separation spring assembly 60. In this regard, the sleeve 30 may comprise an external sleeve 31 and an internal sleeve 32, and, according to some example embodiments, the external sleeve 31 and the internal sleeve 32 may be rotationally fixed such that the sleeves 31 and 32 rotate together as a unit. The bit interface assembly 40 may comprise jaws 20 and a nut 41. The nut 41 may be threaded and configured to engage with threading on the jaws 20 such that, when the nut rotates relative to the jaws 20, the jaws move in an opening or closing direction based on the direction of rotation of the nut 41. According to some example embodiments, the nut 41 may be generally configured to rotate in association with rotation of the sleeve 30. According to some example embodiments, the bit interface assembly 40 may also comprise components for locking the jaws 20 in position on a bit when the jaws 20 are tightened down onto the bit. In this regard, the bit interface assembly 40 may comprise a lock ring 42, bearings 43, and a tooth ring 44, which may operate cooperatively with other components of the chuck 10 to provide a jaw locking functionality. In this regard, the lock ring 42 may operably couple to the nut 41 and the sleeve 30 to rotate with the nut 41 and the sleeve 30 until a threshold torque is reached whereupon the locking functionality is engaged. To do so, according to some example embodiments, the lock ring 42 may comprise locking pawls that engage and disengage with complementary features of the sleeve 30, and ratcheting pawls that engage and disengage with teeth of the tooth ring 44.

The body assembly 70 may comprise a body 71 and a spindle pin 72. As further described below, the spindle pin 72 may be affixed to the body 71 within a spindle cavity of the body 71. According to some example embodiments, the spindle pin 72 may be press fit to the body 71 such that the body 71 and the spindle pin 72 move and operate as a unitary element. As such, according to some example embodiments, the body 71 and the spindle pin 72 may be formed as an integrated component. According to some example embodiments, the body assembly 70 may further comprise the nose 25, which may also be fixedly coupled to the body 71 and operate as a stop to secure components, such as the sleeve 30, in operable coupling with the body 71 at the front end 14 of the chuck 10. Similarly, the body assembly 70 may comprise a snap ring 76 that is operably coupled to the body 71 within a groove of the body 71 disposed at the rear end 13 of the body 71. Although the snap ring 76 may be removable to permit disassembly and maintenance of the chuck 10, the snap ring 76 may operate, similar to the nose 25, in that the snap ring 76 may act as a stop to secure components, such as the collar 50, at the rear end 13 of the chuck 10. Additionally, according to some example embodiments, the body assembly 70 may comprise a washer 75 that may be configured to couple to a washer flange of the body 71. In some example embodiments, the washer 75 may be an integrated extension of the washer flange of the body 71. In either case, the washer 75 may extend radially outward from the body 71 to form an extended surface for receiving one end of the collar spring 55, as further described below.

Additionally, the collar 50, as mentioned above, may be configured to support the quick connect spindle interface of the chuck 10. In this regard, the collar 50 may comprise a graspable exterior for operation as a user interface for drive spindle removal. Additionally, according to some example embodiments, the collar 50 may include internal features configured to engage and disengage a detent member 54 based on a positioning (e.g., axial position relative to the body 71) of the collar 50. According to some example embodiments, the collar 50 may comprise and external collar 51 and an internal collar 52. According to some example embodiments, the external collar 51 may be fixedly attached to the internal collar 52 such that the components move and operate as a unitary component. As such, according to some example embodiments, the external collar 51 and the internal collar 52 may be formed as an integrated component. According to some example embodiments, the collar 50 may be positioned around a rear portion of the body 71 that includes at least one a detent passageway 73. The detent passageway 73 may be a through hole in a sidewall of the rear portion of the body 71 that extends radially relative to the axis 11. The detent passageway 73 may be configured to receive the detent member 54 such that the walls of the detent passageway 73 restrict axial movement of the detent member 54 relative to the body 71 and the axis 11, but openings at the ends of the detent passageway 73 permit radial movement of the detent member 54 relative to the axis 11. Based on the alignment of the collar 50 with the detent passageway 73, the collar 50 may include features that apply forces to move the detent member 54 into various positions to effectuate the quick connect spindle interface. In this regard, the collar 50 may include a collar recess and an engaging surface which, as described further below, interact with the detent member 54 to move the detent member 54 into the various positions in response to movement of the collar 50. According to some example embodiments, the collar 50 may also comprise a detent spring 53, which may be positioned within the collar recess to apply a bias on the detent member 54 and urge the detent member 54 radially inward (i.e., towards the axis 11) and out of an opening in the collar recess (i.e., away from a base of the collar recess).

Additionally, according to some example embodiments, the chuck 10 may include a collar spring 55, which may be configured to apply a bias on the collar 50. The collar spring 55 may, according to some example embodiments, be a coil spring that is positioned around a rear portion of the body 71. According some example embodiments, the collar spring 55 may be disposed forward of the collar 50. However, as described below, in some example embodiments, the collar spring 55 may be disposed rearward of the collar 50. The bias applied by the collar spring 55 on the collar 50 (i.e., the collar spring bias) may also operate to maintain a positioning of the collar 50 and the detent member 54, based on a current engagement state with a drive spindle, as further described below.

The separation spring assembly 60 of the chuck 10 may be configured to apply a bias force on an engaged drive spindle to urge the drive spindle out of engagement with the chuck 10. In this regard, the separation spring assembly 60 may comprise a separation spring 61 and a separation ring 62. The separation spring 61 may create a separation bias that is directed to urge the drive spindle out of engagement with the chuck 10, and the separation ring 62 may be configured to provide an interface surface for contacting the drive spindle. According to some example embodiments, both the separation spring 61 (e.g., a coil spring) and the separation ring 62 (e.g., having a though hole opening) may be positioned around a spindle engaging post 172 of the spindle pin 72. The separation spring 61 may be disposed between the separation ring 62 and a pin flange. According to some example embodiments, the detent member 54 may operate as a stop for the separation spring assembly 60, when the chuck 10 is not engaged with a drive spindle.

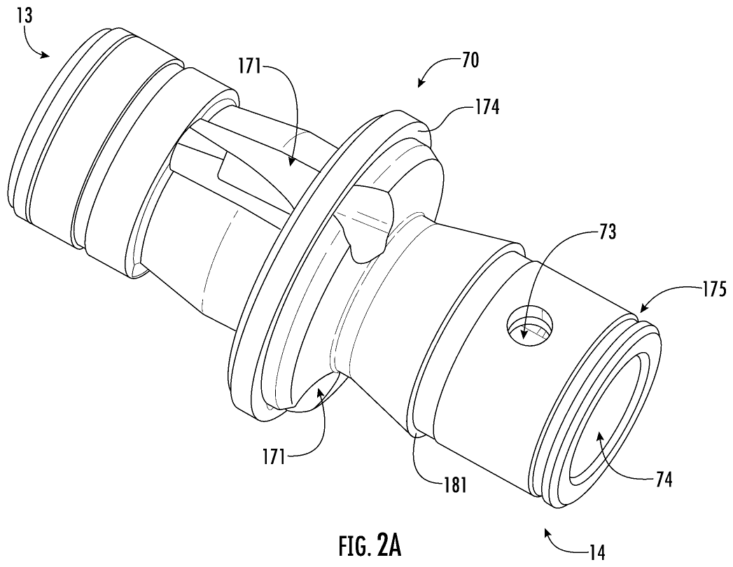

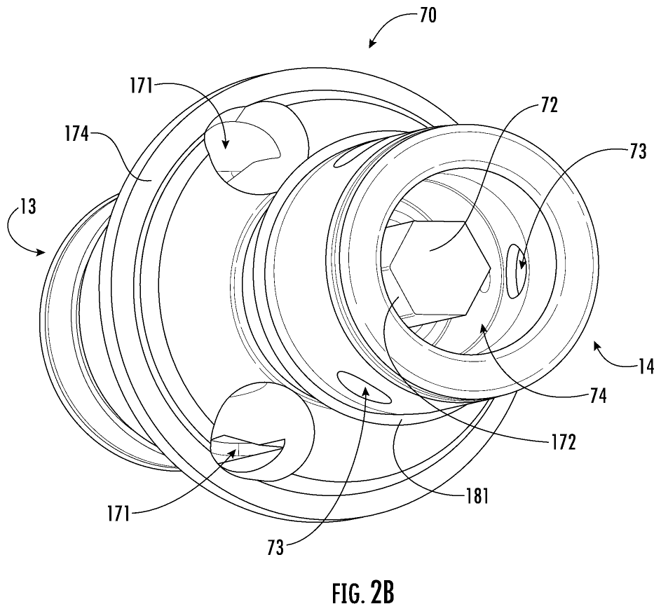

Having described various components of the example chuck 10, a more detailed description of some of the specific components that support the operation of quick connect spindle interface will now be provided. With reference to FIGS. 2A and 2B, a perspective side view and a perspective rear view, respectively, of the body 71 are shown with indications of the front end 13 and the rear end 14. As described above, the body 71, as a component of the body assembly 70, may comprise jaw passageways 171, which are positioned to extend towards the front end 13 of the body 71 to permit movement of jaws 20 in an opening or closing direction. Additionally, and following from the description above, the body 71 may include a washer flange 174. The washer flange 174 may be configured to engage the washer 75 to provide a radially extended surface for contacting the collar spring 55. Additionally, the rear end 14 of the body 71 may comprise the groove 175 configured to receive the snap ring 76, as described above. Also, the body 71 may comprise a collar stop lip 181 disposed around the rearward portion of the body 71 that operates as a forward stop for axial movement of the collar 50 as further described below.

As shown in FIGS. 2A and 2B, the body 71 may also comprise a spindle cavity 74. The spindle cavity 74 may be an open ended bore in a rear end 14 of the body 71. According to some example embodiments, the spindle cavity 74 may be sized to receive a drive spindle of a rotating power tool. The spindle pin 72 may be secured to the body 71 at a forward end of the spindle cavity 74 and the spindle engaging post 172 of the spindle pin 72 may extend into the spindle cavity 74 rearwards toward the rear end opening of the spindle cavity 74. The spindle engaging post 172 may be shaped to facilitate transfer of rotational movement from the drive spindle to the body 71, and thus the chuck 10. In this regard, according to some example embodiments, the spindle engaging post 172 of the spindle pin 72 may have a hexagonal cross-sectional shape.

The rear portion of the body 71 may also include one or more detent passageways 73. In the example embodiment shown in FIG. 2B, the body 71 comprises three detent passageways 73. As mentioned above, the detent passageways 73 may be positioned in the sidewalls of the spindle cavity 74 and may be configured to receive a detent member 54 (e.g., a ball, formed of metal). The sidewalls of the detent passageway 73 may prevent the detent member 54 from moving axially relative to the body 71 with reference to the axis 11, but may permit the detent member 54 to move radially relative to the body 71 within the detent passageway 73 and relative to the body 71.

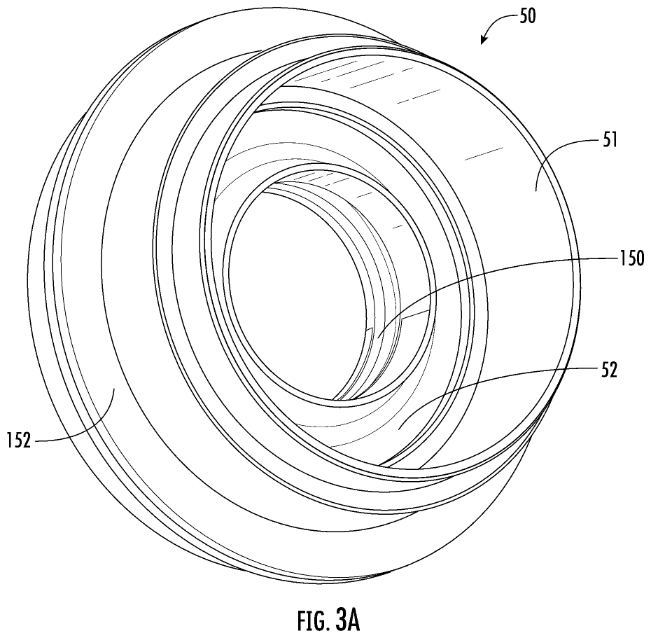

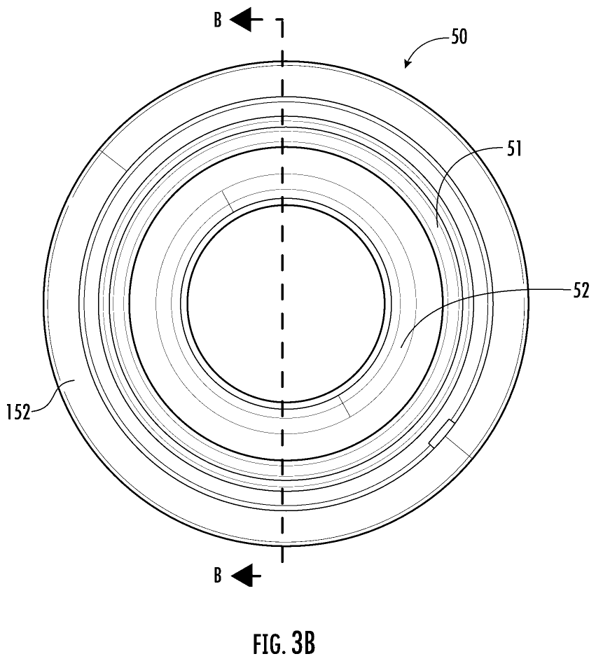

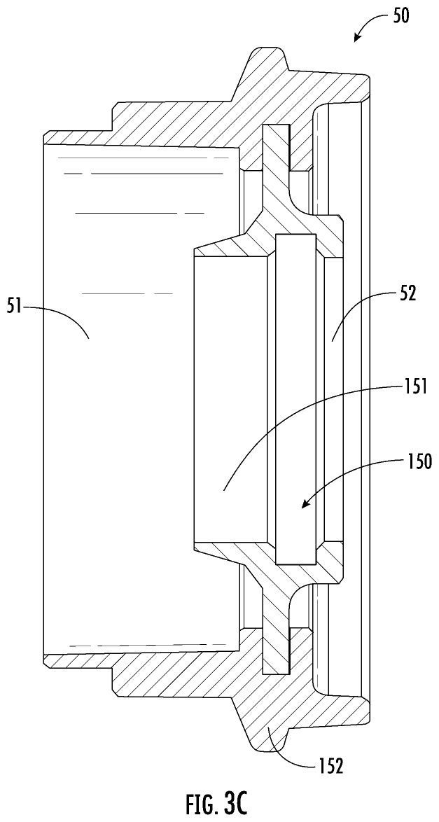

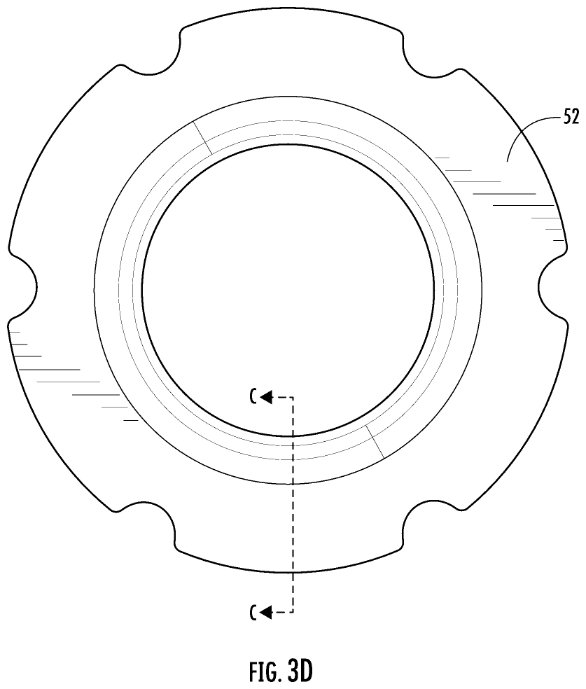

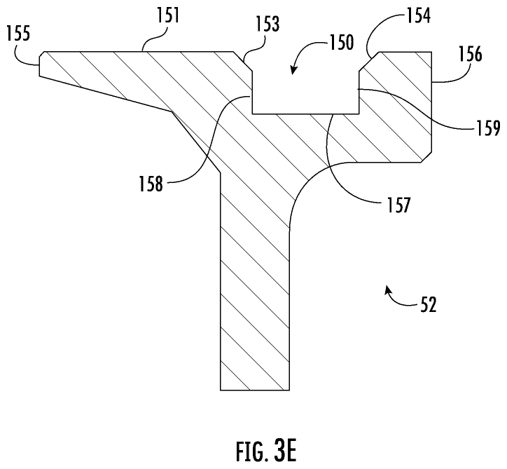

Now referring to FIGS. 3A and 3B, a perspective rear view and a rear view, respectively, of the collar 50 are shown. As mentioned above, the collar 50 may comprise an external collar 51 and an internal collar 52 that may be fixedly coupled or integrated. The internal collar 52 may comprise a collar recess 150 that encircles an interior surface of a central passageway of the internal collar 52 (e.g., an annular recess). According to some example embodiments, the external collar 51 may comprise a radially extending protrusion 152 that may function as a finger grip for permitting a user to grasp and move the collar 50. FIG. 3C illustrates a cross-section view of the collar 50 taken at B-B in FIG. 3B. In this cross-section view it can be seen that the internal collar 52 is affixed to an interior of the external collar 51 via a protrusion of the internal collar 52 extending into a groove of the external collar 51. Further, a structure of the interior surfaces of the internal collar 52 can be seen. In this regard, the collar recess 150 and the collar engaging surface 151 are shown.

As further described below, the interior surfaces of the internal collar 52, according to some example embodiments, may facilitate maneuvering of the detent member 54 into various positions for engaging and disengaging with the drive spindle. To further describe these interior surfaces of the internal collar 52, a cross-sectional shape of a portion of the internal collar 52 taken at C-C in FIG. 3D is shown in FIG. 3E. In this regard, the collar recess 150 may be defined by a recess base surface 157, a forward sidewall 158, and a rearward sidewall 159. The forward sidewall 158 may, according to some example embodiments, comprise a chamfered surface 153 at an interior end of the forward sidewall 158 at the opening of the collar recess 150. Similarly, according to some example embodiments, the rearward sidewall 159 may comprise a chamfered surface 154 at an interior end of the rearward sidewall 159 at the opening of the collar recess 150. Additionally, a collar engaging surface 151 may be disposed forward of the collar recess 150, and the collar engaging surface 151 may be positioned inwardly relative to the recess base surface 157 of the collar recess 150. According to some example embodiments, the internal collar 52 may also include a forward edge 155 disposed on a forward side of the internal collar 52 and the rearward edge 156 disposed at a rear side of the internal collar 52. As further described below, the forward edge 155 and the rearward edge 156 may contact respective surfaces of other components to limit the axial movement of the internal collar 52, and thus the collar 50.

As mentioned above, the interior surfaces of the internal collar 52 may be configured to maneuver the detent member 54 into different positions based on the positioning of the collar 50 relative to the body 71. According to some example embodiments, the collar 50 may be moveable axially, relative to the body 71 and the detent member 54 (since the detent member 54 is disposed within the detent passageway 73 of the body 71). In this regard, the collar 50 may be movable into a spindle disengaged position, a spindle transition position, and a spindle engaged position. In the spindle disengaged position, the collar 50 and the detent member 54 are positioned for receipt of the drive spindle and the drive spindle has not yet moved into contact with the detent member 54. In the spindle transition position, the drive spindle has entered the spindle cavity 74 and has come into contact with the detent member 54. The contact of the drive spindle with the detent member 54 may move detent member 54, which, in turn moves the collar 50 into the spindle transition position. As such, the collar 50 assumes the spindle transition position when the drive spindle has not moved into a position where the detent member 54 is engaged with the drive spindle. The collar 50 may be located in the spindle transition position when the drive spindle is being installed or when the drive spindle is being removed. Finally, in the spindle engaged position, the collar 50 is positioned to move the detent member 54 into engagement with drive spindle such that the chuck 10 is secured to the drive spindle for rotating operation.

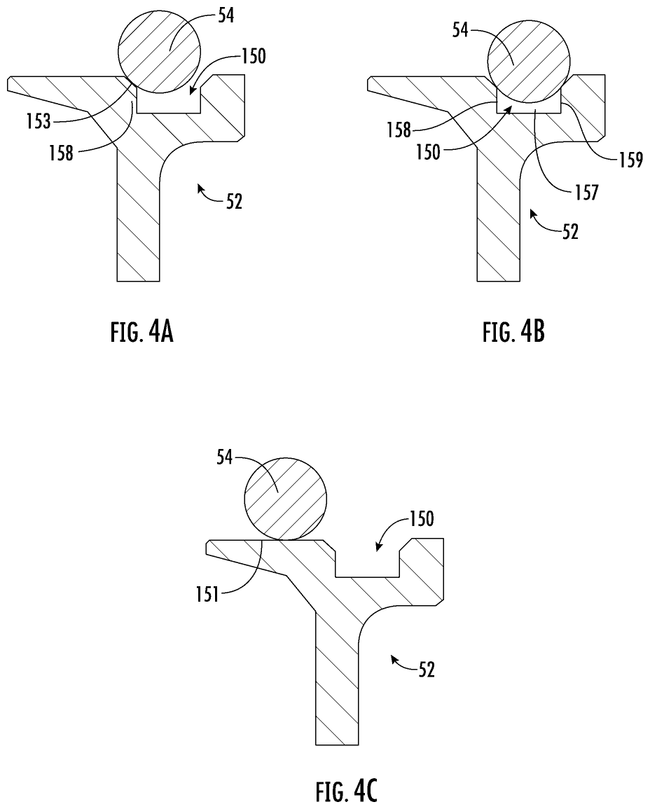

FIGS. 4A-4C illustrate the cross-sectional shape of the portion of the internal collar 52 in various relative positions with the detent member 54 associated with the collar 50 positions described above. In this regard, FIG. 4A illustrates the internal collar 52 in the spindle disengaged position. In the spindle disengaged position, the detent member 54 is partially disposed within the collar recess 150. Further, the detent member 54 is contacting the forward sidewall 158, and more specifically, according to some example embodiments, the chamfered surface 153 of the forward sidewall 158. FIG. 4B illustrates the internal collar 52 in the spindle transition position. When the internal collar 52 is in the spindle transition position, the detent member 54 may be positioned within the collar recess 150 such that the detent member 54 is in contact with both the forward sidewall 158 and the rearward sidewall 159. According to some example embodiments, when the internal collar 52 is in the spindle transition position, the detent member 54 may be moved radially outward into the position where the detent member 54 is disposed within collar recess 150 closest to the recess base surface 157 and furthest from the axis 11. FIG. 4C illustrates the collar 50, and more specifically the internal collar 52 in the spindle engaged position. In the spindle engaged position, the detent member 54 is moved completely out of the collar recess 150, and into a position on the collar engaging surface 151. As such, when the internal collar 52 is moved into the spindle engaged position, the detent member 54 is positioned, according to some example embodiments, in a radially inward position such that the detent member 54 is a closest position to the axis 11.

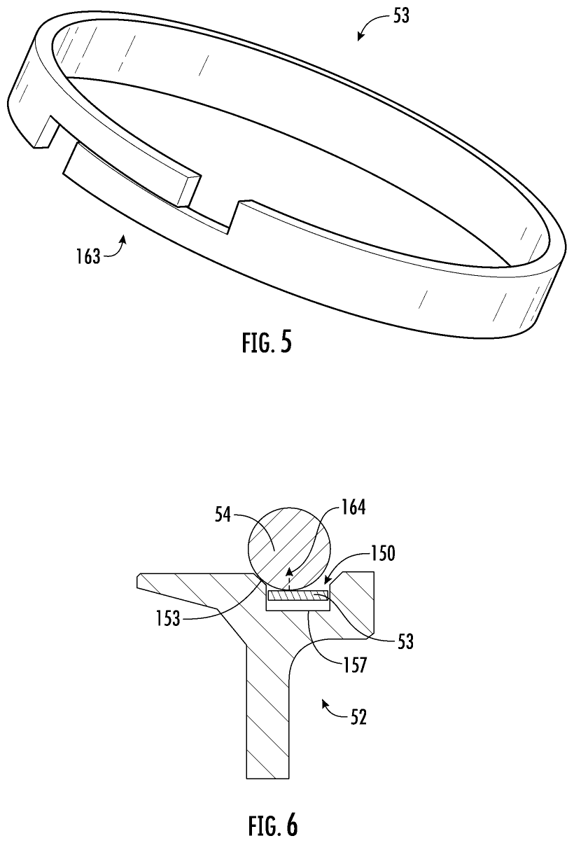

As mentioned above, the chuck 10, according to some example embodiments, may also include a detent spring 53, as shown in FIG. 5. The detent spring 53, according to some example embodiments, may be an annular leaf spring disposed within the collar recess 150. According to some example embodiments, the detent spring 53 may be an annular metal ring with an overlapping discontinuity 163 that permits the ring to deform and flex to generate an inward spring bias. FIG. 6 shows a cross-section shape of the internal collar 52, however, now with the detent spring 53 disposed within the collar recess 150. Accordingly, when, for example, the internal collar 52 is in the spindle disengaged position, the detent spring 53 may apply a detent spring bias in the direction 164, i.e., a force urging the detent member 54 radially inward and away from the recess base surface 57 and out of the collar recess 150. As further described herein, the detent spring bias may urge the detent member 54 radially inward to extend into the spindle cavity 74, which may position the detent member 54 to impede the axial movement of the separation ring 62 towards the rear opening of the spindle cavity 74. In doing so, the detent spring 53 may assist with retaining the separation ring 62 within the spindle cavity 74 when a drive spindle is not present in the spindle cavity 74. Further, in some example embodiments, the detent spring 53 may apply the detent spring bias to position the detent member 54 within the detent passageway 73 to avoid being lodged in an undesirable position, such as lodged within the collar recess 150 during movement of the internal collar 52.

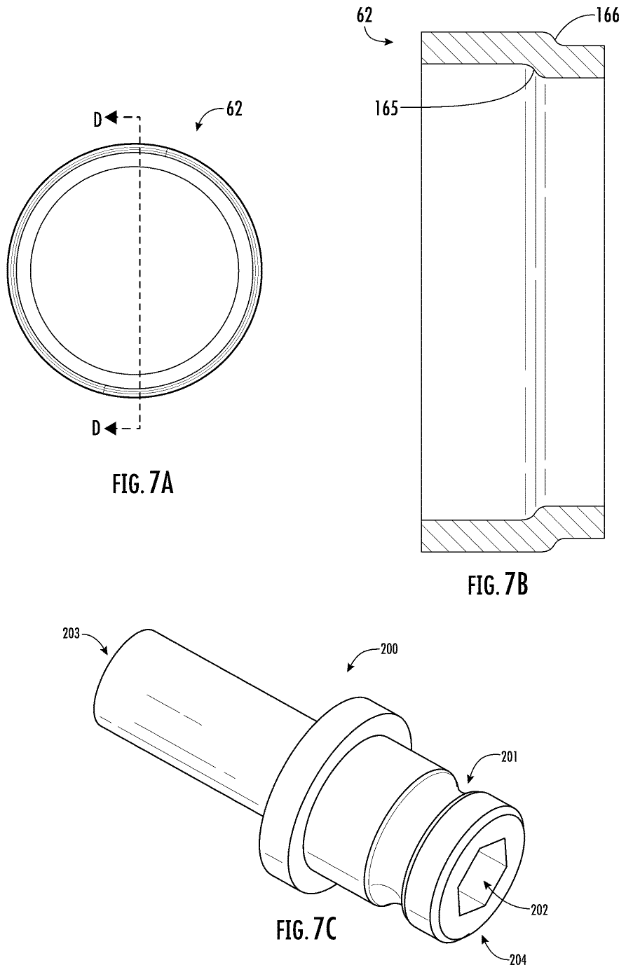

With reference to the separation spring assembly 60, FIGS. 7A and 7B illustrate a rear view and a cross-section view taken at D-D of FIG. 7A of the separation ring 62. The separation ring 62 may be an annular member that is in urged by the separation spring 61 towards a rear end of the chuck 10. According to some example embodiments, the separation ring 62 may have a generally hollow cylinder shape. However, in some example embodiments, the separation ring 62 may include engaging features configured to contact the separation spring 61 and the detent member 54. In this regard, as seen in FIG. 7B, the separation ring 62 may comprise a narrowed portion that forms an internal annular ring lip 165 and an external annular ring ridge 166. According to some example embodiments, the separation spring 61 may be received in the internal hollow of the separation ring 62 such that the separation spring 61 abuts the ring lip 165, which provides a contact surface for the separation spring 61 within the separation ring 62. The ring ridge 166 provides a catch surface for the detent member 54 to engage and an operates as a stop for the separation ring 62 to prevent unimpeded movement of the separation ring 62 rearward and out of the spindle cavity 74, as further described below.

FIG. 7C illustrates an example drive spindle 200, according to some example embodiments. The drive spindle 200 may have a chuck engaging end 204 for engaging a chuck, such as chuck 10, and a rotating power tool end 203 that would be affixed to a rotating power tool that controllably rotates the drive spindle 200. The drive spindle 200 may comprise a detent recess 201 formed as an annular recess on an external surface of the drive spindle 200 near the chuck engaging end 204. The detent recess 201 may be configured to receive the detent member 54 when the drive spindle 200 is engaged with the chuck 10 to secure the chuck 10 to the drive spindle 200. Further, the drive spindle 200 may comprise a spindle pin cavity 202. The spindle pin cavity 202 may have a complementary shape (e.g., hex-shaped hollow) to slidably engage with the spindle engaging post 172. Accordingly, the engagement between the spindle engaging post 172 and the spindle pin cavity 202 may permit rotational movement of the drive spindle 200 to be transferred to the chuck 10, and the detent recess 201 may operate to receive the detent member 54 and lock the chuck 10 to the drive spindle 200 when engaged.

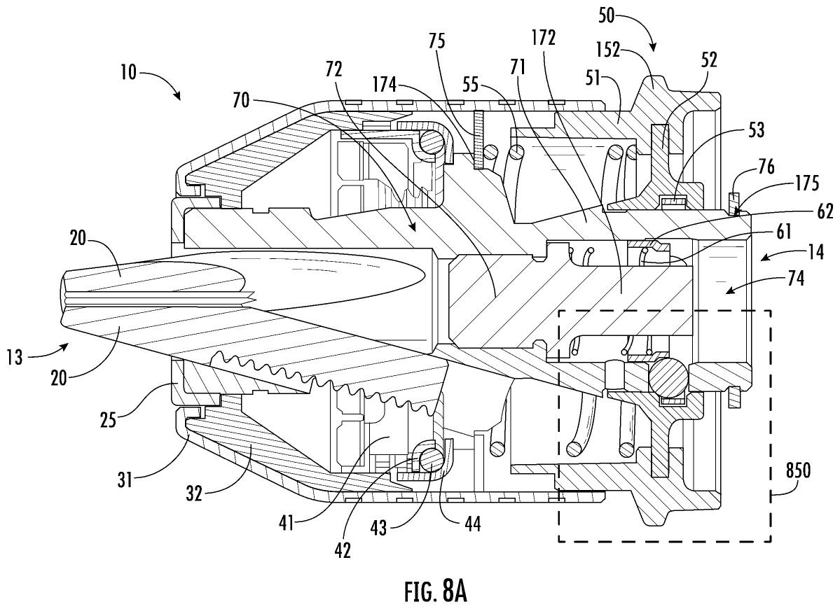

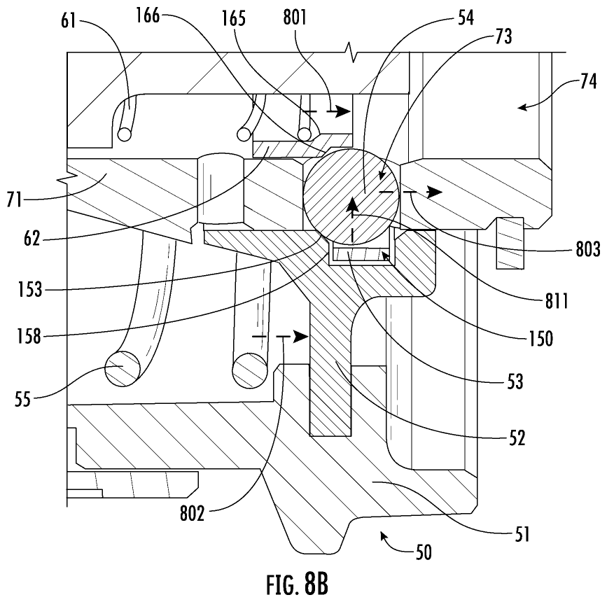

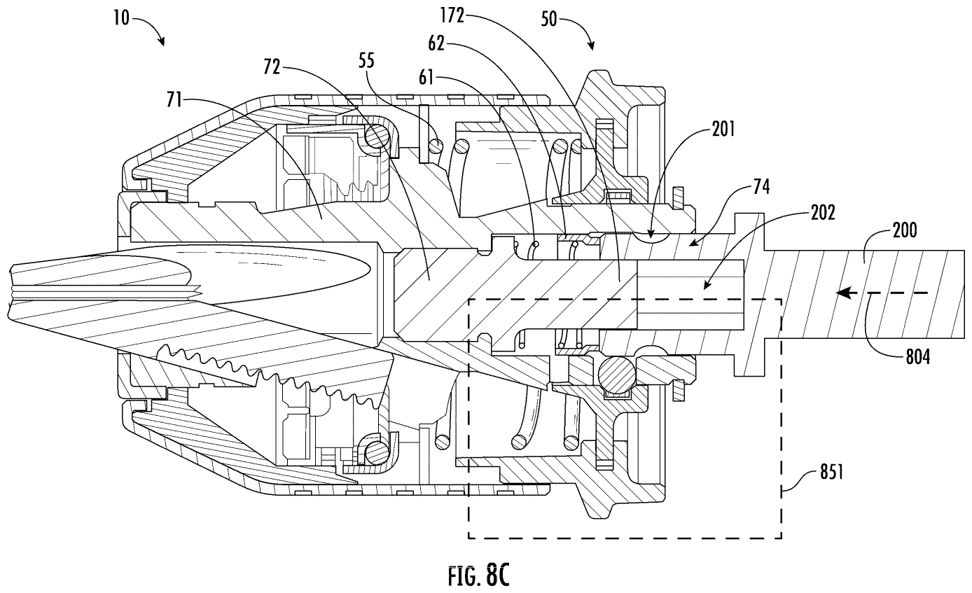

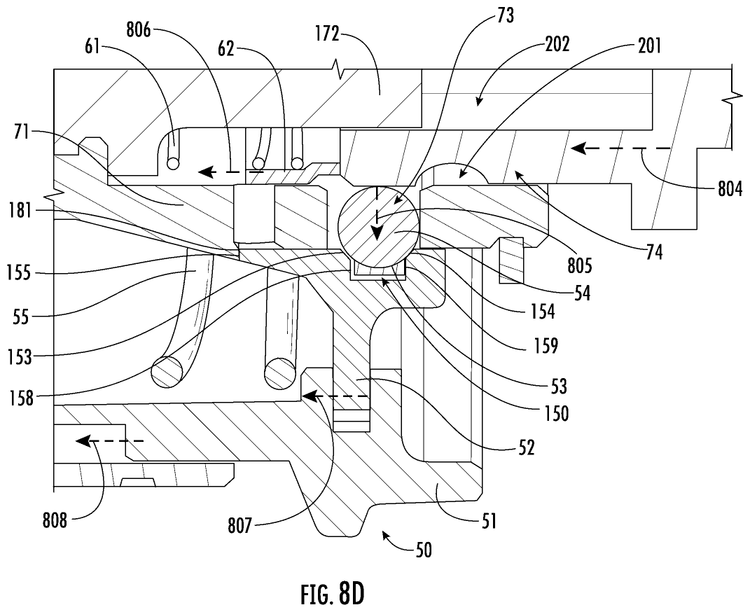

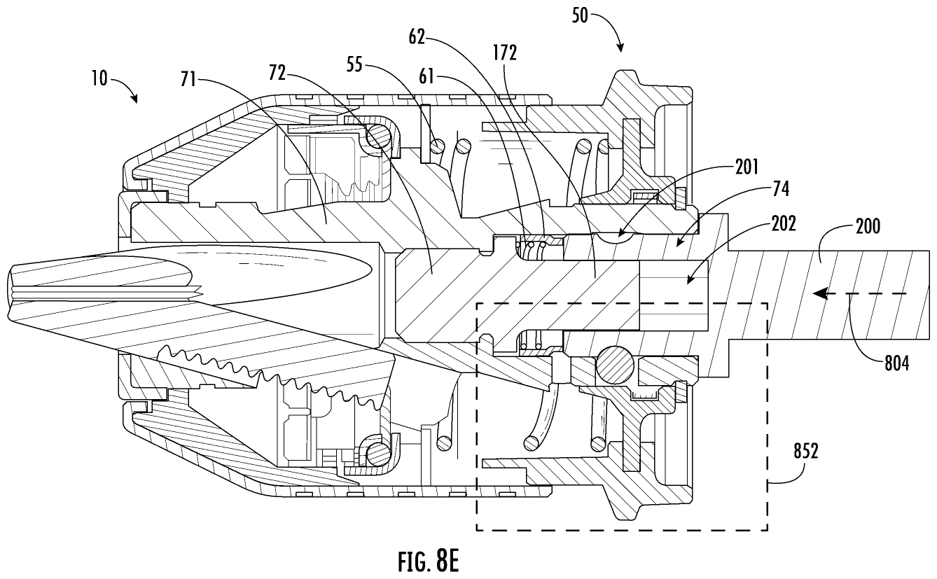

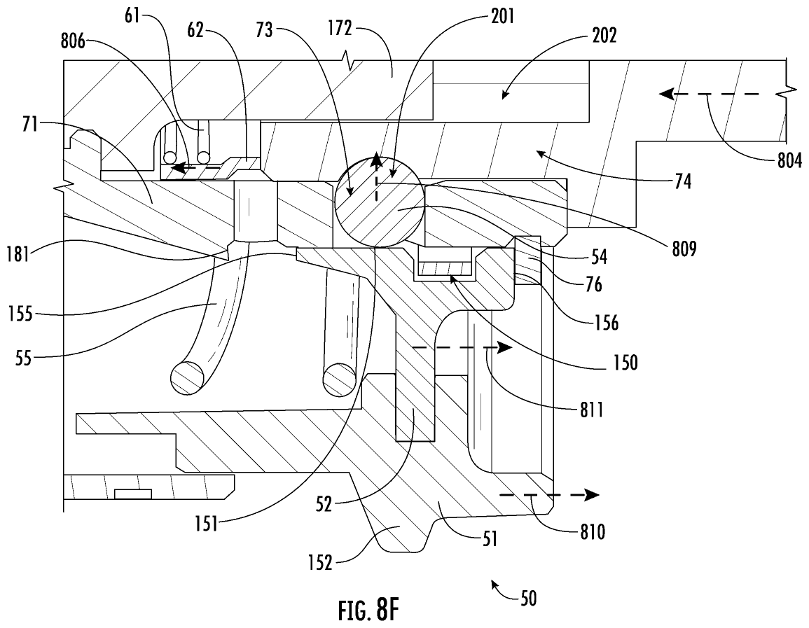

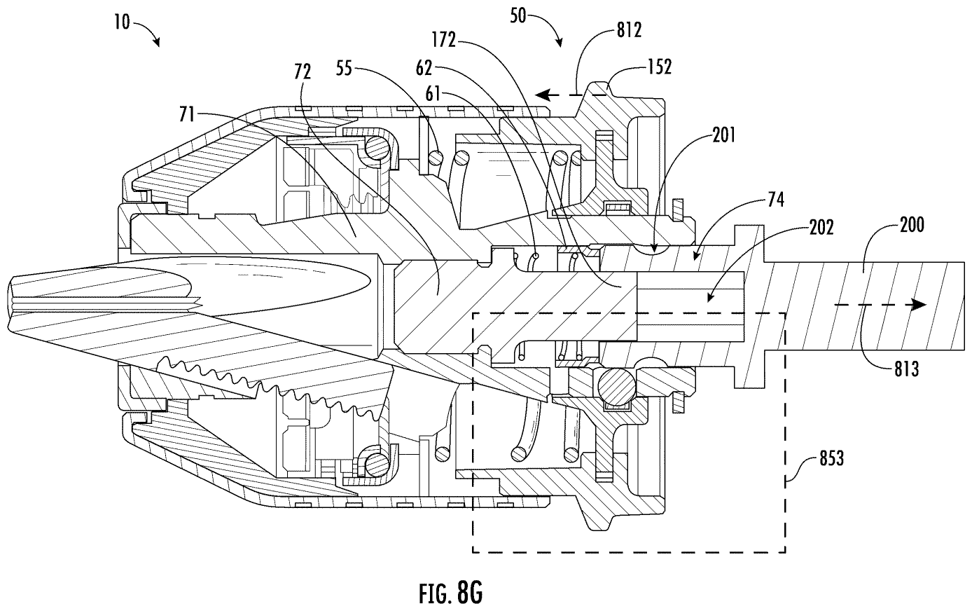

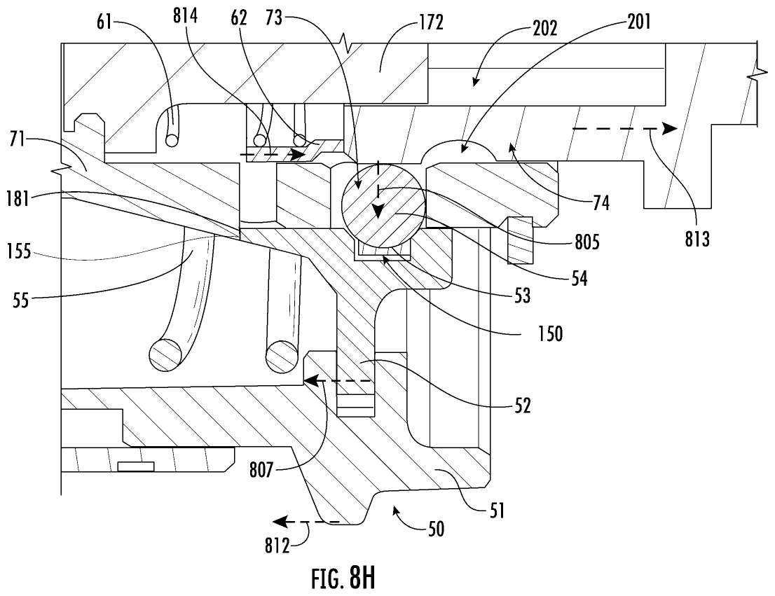

Having described the example structures and interactive features of various components of chuck 10, FIGS. 8A to 8H will now be described which illustrate the operation of the chuck 10 from having no drive spindle 200 in contact (FIGS. 8A and 8B), to having a drive spindle 200 begin to be inserted into the spindle cavity 74 (FIGS. 8C and 8D), to having the drive spindle 200 engaged with the chuck 10 (FIGS. 8E and 8F), to having the drive spindle 200 being removed from the spindle cavity 74 (FIGS. 8G and 8H). FIGS. 8A to 8H show cross-section views of the chuck 10 taken at A-A of FIG. 1B.

In this regard, with reference to FIG. 8A, the chuck 10 is shown with the collar 50 in the spindle disengaged position, since the drive spindle 200 is not present within the spindle cavity 74. As can be seen, the various components of the chuck 10 (as shown in FIG. 1C) are shown in an assembled form. With respect to the example quick connect spindle interface, FIG. 8A shows the collar 50 (comprising the external collar 51 and the internal collar 52) positioned near the rear end 14 of the chuck 10 and coupled around a rear portion of the body 71. The collar 50 also extends forward to nest within the sleeve 30, and more specifically, the outer sleeve 31. The collar spring 55 is shown in a constrained position between the washer 75 (which is disposed on the washer flange 174 of the body 71) and the collar 50 (more specifically the external collar 51). As such, the collar spring 55 may apply a collar spring bias on the collar 50 to urge the collar 50 in a rearward direction. However, because of the engagement with the detent member 54, movement of the collar 50 in the rearward direction has been stopped as further described below. Additionally, the snap ring 76 is installed in the groove 175, and therefore snap ring 78 is positioned to provide a second stop position for the collar 50, as further described below.

Additionally, the spindle pin 72 is shown fixedly attached to the body 71 at a forward end of the spindle cavity 74, with the spindle engaging post 172 extending rearward into the spindle cavity 74 towards the rear opening of the spindle cavity 74. The separation spring 61 and the separation ring 62 are disposed around the spindle engaging post 172, with the separation ring 62 positioned for engagement with a forward end of the drive spindle 200. Additionally, the separation spring 61 is constrained between the body assembly 70, and more specifically a flange of the spindle pin 72, and the separation ring 62. The separation spring 61 therefore applies a separation bias on separation ring 62 the urges the separation ring 62 rearward towards the rear opening of the spindle cavity 74. As further described below, the detent member 54 also operates as a stop for the separation ring 62 and prevents the separation ring 62 from moving rearward past the detent member 54.

Accordingly, with reference to 8A and in view of the detent member 54 and internal collar 52 positional relationship shown in FIG. 4A, it can be seen that the collar 50 is in the spindle disengaged position. FIG. 8B provides a zoomed illustration of the area 850 of FIG. 8A to provide a more detailed view and description of the components. As such, with reference to FIG. 8B, arrows indicating the biasing that is acting upon some of components is shown. In this regard, the detent member 54 is disposed within the detent passageway 73 of the body 71. The detent member 54 has a dimension (e.g., a diameter) that is larger than the length of the detent passageway 73 such that the detent member 54 may be positioned within the detent passageway 73 and have a first portion that extends radially inward beyond the inner surface of the wall of the spindle cavity 74, and a second portion that extends radially outward beyond an outer surface of the wall of the body 71. As such, the detent member 54 may be configured to operate as an interference stop to both the collar 50 and the separation ring 62 of the separation spring assembly 60 when positioned appropriately.

In FIG. 8A, the collar spring bias is applied to the internal collar 52 in the direction 802. As such, due to the positioning of the detent member 54 relative to the internal collar 52, a force due to the collar spring bias is applied to the detent member 54 via the forward sidewall 158, and more specifically in this example embodiment, the chamfered surface 153 of forward sidewall 158. Although the detent member 54 is partially disposed in the collar recess 150 and the detent spring 53 may be urging the detent member 54 radially inward and out of the collar recess 150 in the direction 811, the positioning of the separation ring 62 of the separation spring assembly 60 operates as a radial movement stop to the detent member 54 to maintain the detent member 54 within the collar recess 150. Additionally, the separation spring assembly 60, and more specifically the separation ring 62, may be urged in the direction 801 by the separation bias of the separation spring 61 due to the contact between the separation spring 61 and the ring lip 165. Further, contact between the separation ring 62 and the detent member 54 at the ring ridge 166 may operate to both stop the detent member 54 from moving radially inward and also stop the separation ring 62 from moving axially rearward in the direction 801 due to the urging of the separation bias.

Now referring to FIG. 8C, the chuck 10 is shown with the chuck 10 being installed onto the drive spindle 200. In this regard, the drive spindle 200 is entering the spindle cavity 74 moving in the direction 804, and has come into contact with the detent member 54 and the separation ring 62. Further, the spindle engaging post 172 has entered into the spindle pin cavity 202 of the drive spindle 200.

Accordingly, with reference to FIG. 8C and in view of the detent member 54 and internal collar 52 positional relationship shown in FIG. 4B, it can be seen that the collar 50 is in the spindle transition position. FIG. 8D provides a zoomed illustration of the area 851 of FIG. 8C to provide a more detailed view and description of the components. As such, with reference to FIG. 8D, arrows indicating the movement directions are shown. The drive spindle 200 has moved into the spindle cavity 74 to contact the detent member 54, but the detent recess 201 of the drive spindle 200 is not yet in alignment with the detent member 54. In this regard, the detent member 54 is disposed within the detent passageway 73 of the body 71, but the contact with the external surface of the drive spindle 200 has moved the detent member 54 radially outward in the direction 805, and further into the collar recess 150 against the biasing of the detent spring 53. In this regard, according to some example embodiments, the detent member 54 may be moved into a position where the detent member 54 is in contact with the forward sidewall 158, at least via the chamfered surface 153, and the rearward sidewall 159, at least via the chamfered surface 154. Therefore, as the detent member 54 moves along the chamfered surface 153 of the forward sidewall 158 and against the collar spring bias, the detent member 54 may cause the collar 50 to move axially forward into the spindle transition position such that the collar recess 150 is aligned with the detent passageway 73. The internal collar 52 may move in the direction 807 and the external collar 51 may move similarly in the direction 808. Additionally, the forward edge 155 of the internal collar 52, in some example embodiments, comes into contact with the collar stop lip 181 of the body 71 to also prevent further forward axial movement of the collar 50. However, it is noted that the movement limitation introduced by the stop lip 181 is not necessary since the detent member 54 would still move radially outward into the collar recess 150 in the absence of the stop lip 181. Also, the forward end of the drive spindle 200 has come into contact with the separation spring assembly 60, and more specifically the separation ring 62. As such, the movement of the drive spindle 200 in the direction 804 also moves the separation ring 62 in the direction 806 against the separation bias of the separation spring 61.

Because of the alignment between the detent passageway 73 and the collar recess 150, the drive spindle 200 is able to continue to slide axially into the spindle cavity 74 unimpeded by the detent member 54. Additionally, it is noted that the user of the chuck 10 does not need to specifically actuate or move the collar 50 to perform the installation operation. The chuck 10 can simply be slid on the drive spindle 200, and the contact between the detent member 54 and the drive spindle 200 operates to move the collar 50 into the spindle transition position without the user applying any movement force directly on the collar 50. In other words, for example, the user may simply grasp the chuck 10 by the sleeve 30 and slide the chuck 10 onto the drive spindle 200, and due to the drive spindle 200 contact with the detent member 54, the collar 50 will automatically move into the spindle transition position and ultimately the spindle engaged position (as described below) simply due to the entry of the drive spindle 200 into the spindle cavity 74. This aspect of the installation process, according to some example embodiments, allows for quick and efficient engagement between the chuck 10 and the drive spindle 200.

Now referring to FIG. 8E, the chuck 10 is shown with the chuck 10 engaged with the drive spindle 200. Accordingly, with reference to FIG. 8E and in view of the detent member 54 and internal collar 52 positional relationship shown in FIG. 4C, it can be seen that the collar 50 is in the spindle engaged position. FIG. 8F provides a zoomed illustration of the area 852 of FIG. 8E to provide a more detailed view and description of the components. As such, with reference to FIG. 8F, arrows indicating the movement directions are shown.

In this regard, the drive spindle 200 has entered the spindle cavity 74 moving in the direction 804 into a position where the detent recess 201 is now aligned with the detent member 54 and the detent passageway 73 of the body 71. As such, the detent member 54 is permitted move radially inward in the direction 809 and into the detent recess 201 to secure the chuck 10 to the drive spindle 200. The radial inward movement of the detent member 54, moves the detent member 54 out of contact with the forward sidewall 158 of the collar recess 150, and therefore the internal collar 52 is permitted to move rearward in the direction 811 unimpeded by the detent member 54 due to the rearward directed collar spring bias on the internal collar 52. Accordingly, the external collar 51 moves with the internal collar 52 in the direction 810. The rearward movement of the collar 50, due to the collar spring bias, is stopped by contact of the rearward edge 156 of the internal collar 52 with the snap ring 76. With the internal collar 52 in this position and because the detent member 54 has moved radially inward and out of the collar recess 150, the detent member 54 is able to move onto the collar engaging surface 151, where the detent member 54 is held in this radial position constrained from movement out of the detent recess 201 by the collar engaging surface 151.

The drive spindle 200 continues to be in contact with the separation ring 62 and the further movement of the drive spindle 200 into the spindle cavity 74 has moved the separation ring 62 forward in the direction 806. However, the separation bias is still applied to the drive spindle 200 to urge the drive spindle 200 in the rearward direction. As such, this force on the drive spindle 200 causes additional engagement between the detent member 54 and the drive spindle 200 at a forward sidewall of the detent recess 201 to further secure the chuck 10 onto the drive spindle 200.

With the collar 50 in the spindle engaged position, no relative movement between the drive spindle 200 and the chuck 10 can occur. The collar spring bias operates to hold the collar 50 in the spindle engaged position. In this position, the only means to remove the drive spindle 200 from the chuck 10 is via intentional user movement of the collar 50, possible via grasping the protrusion 152. In other words, installation of the chuck 10 onto the drive spindle 200, according to some example embodiments, does not require user interaction with the collar 50. However, removal of the chuck 10 from the drive spindle 200, according to some example embodiments, will require user interaction with the collar 50, which is desirable.

Now referring to FIG. 8G, the chuck 10 is shown with the chuck 10 being removed from the drive spindle 200. In this regard, the user has moved the collar 50 forward to align the detent member 54 with the collar recess 150, which permits removal of the drive spindle 200 from the spindle cavity 74. Accordingly, with reference to 8G and in view of the detent member 54 and internal collar 52 positional relationship shown in FIG. 4B, it can be seen that the collar 50 is again moved into the spindle transition position. FIG. 8H provides a zoomed illustration of the area 853 of FIG. 8G to provide a more detailed view and description of the components. As such, with reference to FIG. 8H, arrows indicating the movement directions are shown.

As mentioned above, the user has moved the collar 50 axially forward, and because the body assembly 70 is engaged with the drive spindle 200 via the detent member 54, the collar 50 is able to move axially, relative to the body assembly 70, and more specifically the body 71, the detent member 54, and the drive spindle 200. Since the chuck 10 is secured to the drive spindle 200, the user, presumably also holding the rotating power tool affixed to the drive spindle 200, may simply grasp collar 50 (e.g., protrusion 152) and urge the collar 50 in the forward direction, against the collar spring bias. Such movement of the collar 50, and more specifically the internal collar 52 and the external collar 51, occurs in the directions 807 and 812, respectively, to move the collar 50 into the spindle transition position where the collar 50 is stopped via engagement between the forward edge 155 of the internal collar 52 coming into contact with the collar stop lip 181 of the body 71.

As the collar 50 moves in the forward direction, the collar recess 150 moves into a radially aligned position with the detent passageway 73 and the detent member 54. As such, the detent member 54 is able to move radially outward and into the collar recess 150. In this regard, the separation bias applied to the separation ring 62 urges the chuck 10 away from the drive spindle 200. In doing so, the separation bias is applied to the drive spindle 200 thereby causing an axial force be applied. Due the curvature of the detent recess 201 and the detent member 54, according to some example embodiments, the axial force may cause the drive spindle 200 to move rearward in the direction 813, thereby forcing the detent member 54 radially outward by riding along the rounded forward sidewall of the detent recess 201 and into the collar recess 150. With the detent member 54 no longer extending into the spindle cavity 74, the drive spindle 200 is able to move rearward in the direction 813 in response to the separation bias applied by the separation ring 62 to also move the separation ring 62 in the direction 814. In this regard, according to some example embodiments, the bias applied by the detent spring 53 may be tailored to ensure that the separation bias is able to overcome the bias of the detent spring 53 to move the detent member 54 into the collar recess 150 against the bias of the detent spring 53. With the detent member 54 disengaged from the detent recess 201, the separation bias may assist the user by forcing the drive spindle 200 out of the spindle cavity 74. As such, the components are moved into the same positions as described with respect to FIG. 8D, however, with the drive spindle 200 being moved in a rearward direction.

As such, via simple forward movement of the collar 50 by the user, the chuck 10 operates to quickly disengage from the drive spindle 200. Such movement, according to some example embodiments, may be intuitive to the user since the forward direction would be natural direction for moving the chuck 10 away from the drive spindle 200. Additionally, due to the effect of the separation bias, the chuck 10 is urged away from the drive spindle 200 during a removal operation to further facilitate ease and efficiency in the removal process.

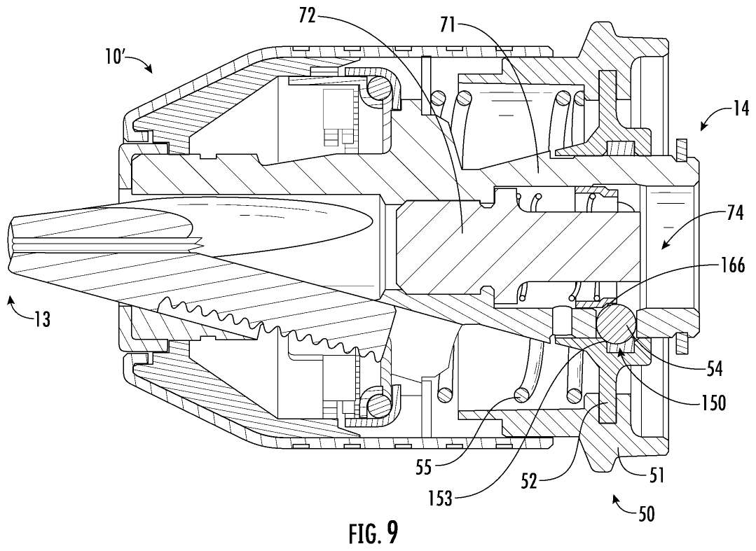

Having described various example embodiments in association with the description of the chuck 10, some additional example embodiments will now be described that incorporate further variations of a quick connect spindle interface according to some example embodiments. In this regard, such additional example embodiments will be described with respect to FIGS. 9 to 11C. The example chucks illustrated in FIGS. 9, 10, and 11A have a similar external structure to that of chuck 10, and the FIGS. 9, 10, and 11A are cross-section views of such additional example chucks taken at a plane defined in the same manner as A-A in FIG. 2.

With reference to FIG. 9, a chuck 10′ is provided that is similar to the chuck 10, with the exception that the detent spring 53 is not included. As such, in the absence of a bias to urge the detent member 54 out of the collar recess 150, operation of the chuck 10′ relies on the various contact surfaces for the detent member 54 to position the detent member 54 during operation. In this regard, the chamfer surface 153 and the ring ridge 166 may be sufficient to maintain the detent member 54 in position when the collar 50 is in the spindle disengaged position, as shown in FIG. 9. Further, according to some example embodiments, the separation spring assembly 60 may be assembled in a manner such that the separation spring 61 is fixedly coupled to the body assembly 70 (e.g., vis the spindle pin 72) and the separation ring 62 is fixedly coupled to the separation spring 61 (e.g., press fit, welded, etc.). Alternatively, the spindle cavity 74 may comprise a stop feature that may operate to impede movement of the separation ring 62 in a rearward direction in the event that a drive spindle 200 is not installed in the spindle cavity 74 and the detent member 54 does not extend into the spindle cavity 74 due to a user moving the collar 50 into the spindle transition position without a drive spindle 200 within the spindle cavity 74. Otherwise, in comparison with the chuck 10, the chuck 10′ would operate in the same or similar manner as the chuck 10 with the collar 50 moving between the spindle disengaged position, the spindle transition position, and the spindle engaged position.

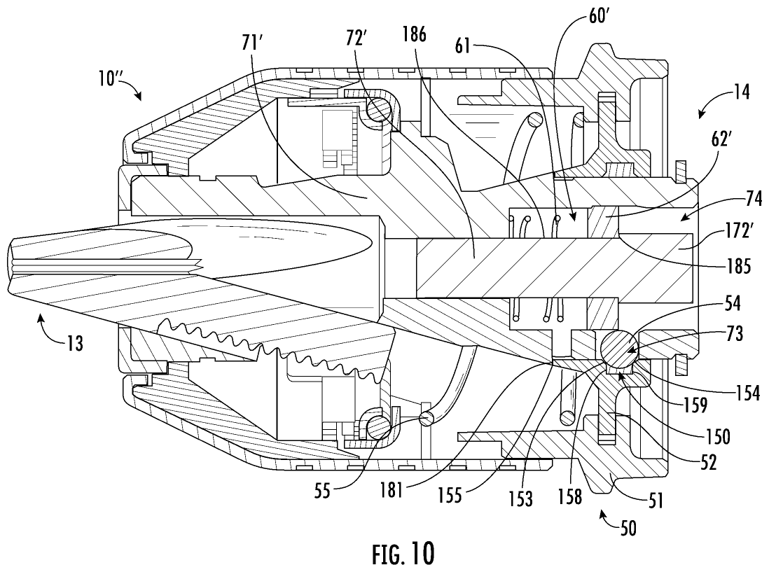

With reference to FIG. 10, an alternative example embodiment of a chuck 10″ is provided with a modified separation spring assembly 60′. More specifically, a modified separation ring 62′ and spindle pin 72′ are shown. In this regard, in place of the separation ring 62, the separation spring assembly 60′ may comprise separation ring 62′, which may be structured as a hollow cylinder. In this regard, the separation ring 62′ may comprise a cylindrical inner surface and a cylindrical outer surface. The cylindrical inner surface may be complementary to an external travel surface 186 of the spindle pin 72′. The cylindrical outer surface may be complementary to the interior surface of the spindle cavity 74.

The modified spindle pin 72′ may be affixed to the body 71 in the same manner as described above with respect to the spindle pin 72. However, the structure extending into the spindle cavity 74 may be different. In this regard, the spindle pin 72′ may comprise the external travel surface 186 extending from the forward end of the spindle cavity 74. According to some example embodiments, the external travel surface 186 may be a surface upon which the separation ring 62′ may travel when in axial moving contact with a drive spindle 200. The spindle pin 72′ may also comprise a stop ridge 185 disposed at a rearward end of the external travel surface 186. The stop ridge 185 may impede rearward movement of the separation ring 62′, due to the separation bias applied by the separation spring 61, beyond the stop ridge 185. According to some example embodiments, the stop ridge 185 may be positioned such that the separation ring 62′ aligns, at least partially with the detent member 54 and the detent passageway 73 when the separation ring 62′ is positioned against the stop ridge 185. In this manner, the separation ring 62′ may maintain the detent member 54 within the detent passageway 73 when the separation ring 62′ is positioned against the stop ridge 185. Additionally, rearward of the stop ridge 185, the spindle pin 72′ may comprise a spindle engaging post 172′ that is shaped similar to the spindle engaging post 172 for engaging the drive spindle 200.

In operation, the collar 50 of the chuck 10″ may be configured to move between the spindle disengaged position and the spindle engaged position. Relative to the chuck 10 or the chuck 10′, the spindle disengaged position and the spindle transition position may be the same for the chuck 10″. As shown in FIG. 10, the detent member 54 is retracted from the spindle cavity 74 and is disposed within the collar recess 150. As such, when the drive spindle 200 enters or exits the spindle cavity 74, the detent member 54 is maintained in this radially retracted position, and therefore the relative movement of the collar 50 and the detent member 54 does not result in a relative position similar to the spindle disengaged position for the chuck 10 (as shown in FIG. 4A). According to some example embodiments, another alternative to the chuck 10″ may include the detent spring 53 within the collar recess 150, which would operate in the same or similar manner as described above.

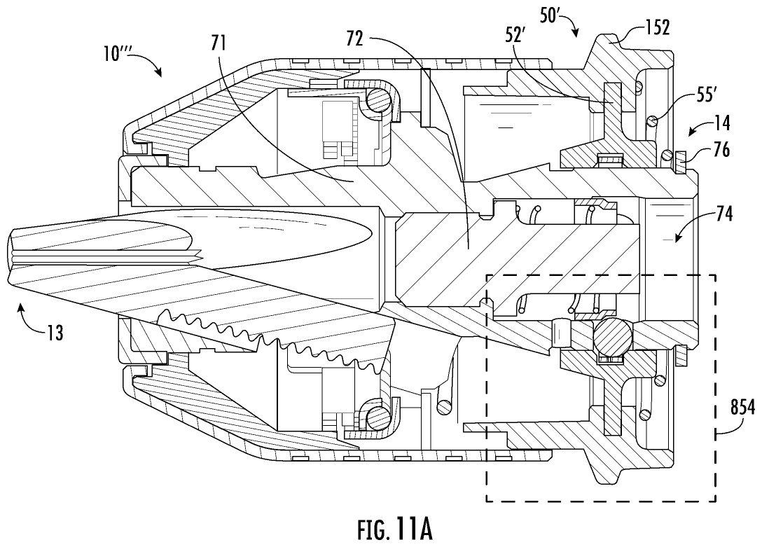

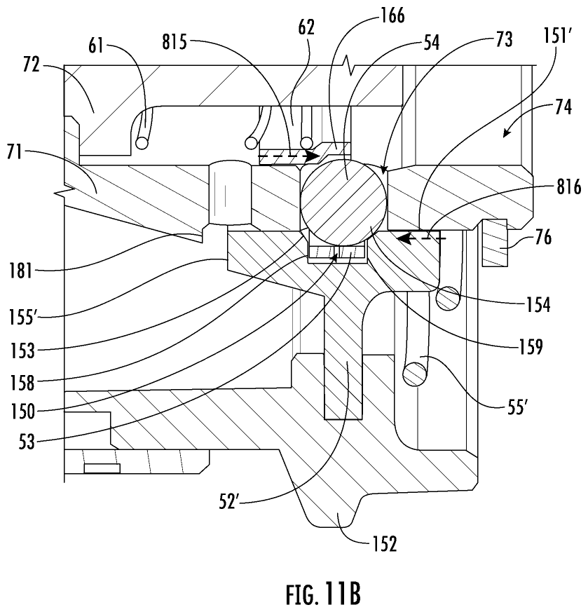

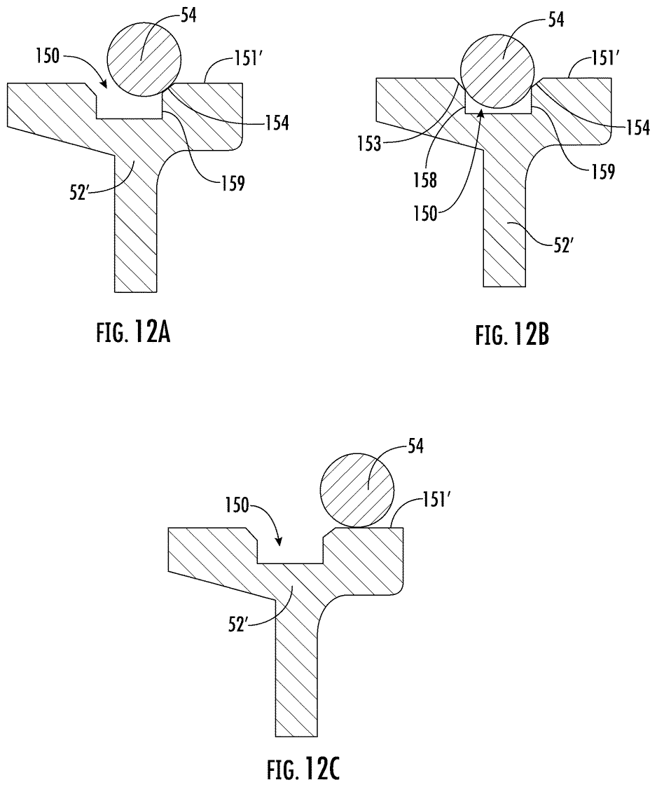

Now referring to FIGS. 11A to 12C, yet another example embodiment of a chuck having a quick connect spindle interface is described. In this regard, chuck 10′″ is similar to the chuck 10 with the differences involving placement of the collar spring and the structure of the collar, and more specifically the internal collar. In this regard, the chuck 10′″ may comprise the elements of chuck 10 with the collar spring 55′ substituted for the collar spring 55, and the internal collar 52′ (of a collar 50′) substituted for the internal collar 52.

Accordingly, with reference to FIGS. 11A and 11B, FIG. 11A illustrates a cross-section view of the chuck 10′″, and FIG. 11B provides a zoomed illustration of the area 854 of FIG. 11A to provide a more detailed view and description of the components. As such, with reference to FIG. 11B, arrows indicating the bias directions are shown. Additionally, FIGS. 12A, 12B, and 12C illustrate a cross-section shape of a portion of the internal collar 52′ (similar to FIGS. 4A, 4B, and 4C). FIG. 12A illustrates the relative positioning of the internal collar 52′ and the detent member 54 when the internal collar 52′ is in the spindle disengaged position. FIG. 12B illustrates the relative positioning of the internal collar 52′ and the detent member 54 when the internal collar 52′ is in the spindle transition position. Finally, FIG. 12C illustrates the relative positioning of the internal collar 52′ and the detent member 54 when the internal collar 52′ is in the spindle engaged position.

In this regard, the collar spring 55′ may be a coil spring that receives a rear portion of the body 71 in a central opening. However, unlike the collar spring 55, the collar spring 55′ is disposed rearward of the internal collar 52′. The collar spring 55′ may be constrained between a rearward surface of the internal collar 52′ and the snap ring 76. As such, the collar spring bias may be oriented to urge the internal collar 52′ and thus the collar 50′ in a forward direction 816. The internal collar 52′ may include the collar recess 150 having the forward sidewall 158 with chamfer surface 153 and the rearward sidewall 159 with chamfered surface 154. According to example embodiments, the detent spring 53 may be disposed in the collar recess 150, or the detent spring 53 may be omitted. Relative to the internal collar 52, the structure of the internal collar 52′ may differ with respect to the positioning of the collar engaging surface. The collar engaging surface 151 is disposed on the forward side of the collar recess 150, whereas the collar engaging surface 151′ is disposed rearward of the collar recess 150. This due to the different direction of the collar spring bias. The separation spring assembly 60 may be configured and operate in the same manner in the chuck 10′″, with the separation bias of the separation spring 61 being oriented to urge the separation ring 62 rearward in the direction 815. As such, unlike the chuck 10, the separation bias and the collar spring bias in the context of chuck 10′″ are oriented in opposite directions with the separation bias being directed rearward and the collar spring bias being directed forward.

In operation, the internal collar 52′ may be positioned in the spindle disengaged position, the spindle transition position, or the spindle engaged position. However, the relative position of the internal collar 52′ to the detent member 54 is different than the internal collar 52 relative to the detent member 54 in these positions. FIG. 11B illustrates the internal collar 52′ in the spindle disengaged position (also shown in FIG. 12A). As can be seen, the detent member 54 is disposed in the detent passageway 73 of the body 71 and is extending into the spindle cavity 74 to contact the ring ridge 166 of the separation ring 62. As mentioned above, due to the separation bias, the separation ring 62 is urging the detent member 54 towards the rear sidewall of the detent passageway 73. The detent member 54 also extends into the collar recess 150, when the internal collar 52′ is in the spindle disengaged position. In this regard, the collar spring 55′ causes the internal collar 52′ to be urged in the forward direction and therefore the detent member 54 operates as a stop for the internal collar 52′ to impede the forward movement of the internal collar 52′ due to the collar spring bias. As such, the detent member 54 may be in contact with the rear sidewall 159 and the chamfered surface 154, and, due to this contact, the internal collar 52′may urge the detent member 54 toward the forward sidewall of the detent passageway 73.

When a drive spindle 200 is received into the spindle cavity 74 and is moving in a forward direction, the drive spindle 200 may come into contact with the detent member 54 and force the detent member 54 radially outward and further into the collar recess 150. Such radial outward movement of the detent member 54 further into the collar recess 150 can cause a transfer of movement to the internal collar 52′ and move the internal collar 52′ in a rearward direction, against the collar spring bias. This positioning of the internal collar 52′ and the detent member 54 is shown in FIG. 12B, which is associated with the spindle transition position. As can be seen in FIG. 12B, the detent member 54 may be in contact with the chamfer surface 153 of the forward sidewall 158 and the chamfered surface 154 of the rearward sidewall 159. As described above, such positioning of the internal collar 52′ during receipt of the drive spindle 200 is the same positioning that occur during removal of the drive spindle 200.

Further, during receipt or installation of the drive spindle 200, the drive spindle 200 may continue to move forward into engagement with the chuck 10′″. In this regard, the drive spindle 200 may move into a position where the detent recess 201 is aligned with the detent member 54 and the detent passageway 73. As such, the detent member 54 may be permitted (possibly due to the bias of the detent spring 53) to move radially inward and into engagement with the detent recess 201. With the detent member 54 no longer in contact with the rear sidewall 159 due to the radial inward movement, the internal collar 52′ is permitted to move forward unimpeded by the detent member 54 due to the collar spring bias. As such, the collar engaging surface 151′ moves forward an into alignment with the detent member 54 and the detent passageway 73 to radially secure the detent member 54 in position in engagement with the detent recess 201 of the drive spindle 200. The collar stop lip 181 of the body 71 may operate as a stop when the internal collar 52′ has moved forward such that the forward edge 155′ of the internal collar 52′ has come into contact with the collar stop lip 181. Accordingly, the internal collar 52′ and the detent member 54 may be relatively positioned as shown in FIG. 12C, which is associated with the spindle engaged position.

Similar to the chuck 10, the user of the chuck 10″″ may simple move the chuck 10″″ onto the drive spindle 200 without otherwise expressly moving, for example, the collar 50′ by hand. Accordingly, the chuck 10′″ may move into engagement in a quick and efficient manner during installation. For removal of the drive spindle 200 from the chuck 10′″, the user may grasp the protrusion 152 of the collar 50′ and move the collar 50′ rearward. Once the collar recess 150 of the internal collar 52′ aligns with the detent member 54 and the detent passageway 73, the separation bias may force the detent member 54 radially outward into the collar recess 150 due to the curvature of the detent recess 201. Once the detent member 54 is no longer extending into the spindle cavity 74, the separation bias applied by the separation ring 62 on the drive spindle 200 will urge the drive spindle 200 in a rearward direction and out of the rear opening of the spindle cavity 74.

Having described various aspects of example embodiments, the following provides recitations of some example embodiments in a variety of combinations. According to a first example embodiment, a chuck for use with a rotating power tool having a drive spindle is provided. The chuck may comprise a plurality of jaws configured to open or close to install or remove a bit, and a body assembly comprising a spindle cavity configured to receive the drive spindle. The body assembly may also be configured to translate rotation of the drive spindle about a center axis of the chuck to the plurality of jaws to rotate the bit. The chuck may also comprise a detent member that may be moveable relative to the body assembly. The detent member may be movable to engage with the drive spindle to secure the drive spindle to the chuck and disengage from the drive spindle to permit removal of the drive spindle from the chuck. The chuck may also comprise a collar comprising a collar recess and a collar engaging surface. The collar may be axially movable relative to the body assembly and the detent member into a spindle disengaged position and a spindle engaged position. Further, the chuck may comprise a collar spring operably coupled to the collar to apply a collar spring bias on the collar, and a separation spring assembly disposed within the spindle cavity and configured to apply a separation bias on the drive spindle when the separation spring assembly is engaged with the drive spindle within the spindle cavity. When the collar is in the spindle disengaged position and the detent member is not engaged with the drive spindle, the detent member may be at least partially disposed within the collar recess and both the collar and the separation spring assembly may apply bias forces on the detent member. When the collar is in the spindle engaged position and detent member is engaged with the drive spindle, the detent member may move out of the collar recess and onto the collar engaging surface to inhibit radial movement of the detent member.

According to a second example embodiment, the first example embodiment may be modified such that the collar is configured to be moved relative to the body assembly, by a user, in a direction against the collar spring bias on the collar, from the spindle engaged position to a spindle transition position to remove the drive spindle from the chuck. In the spindle transition position, the collar may also be positioned such that the detent member aligns with the collar recess to disengage the detent member from the drive spindle and permit the separation bias to force the drive spindle towards an opening of the spindle cavity.

According to a third example embodiment, the second example embodiment may be modified such that the body assembly comprises a collar stop surface. Further, the collar stop surface may contact the collar to stop movement of the collar beyond the spindle transition position.

According to a fourth example embodiment, any of the first through third example embodiments may be modified such that the collar is configured to be moved relative to the body assembly in a direction against the collar spring bias, from the spindle disengaged position to a spindle transition position to install the chuck onto the drive spindle. In the spindle transition position, the collar may be positioned such that the detent member aligns with the collar recess to permit the detent member to move radially out of the spindle cavity and permit continued entry of the drive spindle into the spindle cavity.

According to a fifth example embodiment, any of the first through fourth example embodiments may be modified such that the collar spring bias urges the collar in an opposite direction than the separation spring assembly urges the drive spindle.

According to a sixth example embodiment, any of the first through fifth example embodiments may be modified such that the chuck further comprises a detent spring disposed in the collar recess and configured to urge the detent member into contact with the separation spring assembly or the drive spindle.

According to a seventh example embodiment, any of the first through sixth example embodiments may be modified such that the body assembly comprises a spindle pin disposed within the spindle cavity and configured to operably couple with the drive spindle. The separation spring assembly may comprise a separation spring and a separation ring with a ring opening, and the spindle pin may be disposed within the ring opening.

According to an eighth example embodiment, the seventh example embodiment may be modified such that the separation spring is a coil spring that coils around the spindle pin.

According to a ninth example embodiment, the seventh example embodiment may be modified such that the spindle pin comprises a stop ridge configured to stop movement of the separation ring towards an opening of the spindle cavity due to the separation bias.

According to a tenth, example embodiment, the seventh example embodiment may be modified such that the separation ring comprises a ring ridge configured to contact the detent member to stop movement of the separation ring towards an opening of the spindle cavity due to the separation bias.

According to an eleventh example embodiment, any of the first through tenth example embodiments may be modified such that the chuck further comprises a snap ring coupled to the body assembly. When the collar is in the spindle engaged position and detent member is engaged with the drive spindle, movement of the collar in a direction towards an opening of the spindle cavity due to urging by the collar spring may be stopped by the snap ring to maintain the collar in the spindle engaged position.

According to a twelfth example embodiment, any of the first through eleventh example embodiments may be modified such that the body assembly comprises a detent passageway in a sidewall of the spindle cavity. The detent member may be disposed within the detent passageway.

According to a thirteenth example embodiment, any of the first through twelfth example embodiments may be modified such that the collar comprises a sidewall of the collar recess. The sidewall may comprise a chamfer surface. The detent member may be urged against the chamfer surface of the sidewall when the collar is in the spindle disengaged position.

According to a fourteenth example embodiment, any of the first through thirteenth example embodiments may be modified such that the detent member is a ball. The chamfer surface of the sidewall may operate as a ramp to move the ball out of the collar recess and onto the collar engaging surface when the collar moves from the spindle disengaged position to the spindle engaged position.

Another example embodiment is a fifteenth example embodiment of another chuck for use with a rotating power tool having a drive spindle. According to the fifteenth example embodiment, the chuck may comprise a plurality of jaws configured to open or close to install or remove a bit, a body assembly being configured to translate rotation of the drive spindle about a center axis of the chuck to the plurality of jaws, a detent member movable to engage with the drive spindle to secure the drive spindle to the chuck and disengage from the drive spindle to permit removal of the drive spindle from the chuck, and a collar comprising a collar recess. The collar may be axially movable relative to the body assembly into a spindle disengaged position and a spindle engaged position. The chuck may also comprise a collar spring operably coupled to the collar to apply a collar spring bias on the collar, and a separation spring assembly operably coupled to the body assembly and configured to apply a separation bias on the drive spindle when the separation spring assembly is engaged with the drive spindle. When the collar is in the spindle disengaged position and the detent member is not engaged with the drive spindle, the detent member may be at least partially disposed within the collar recess and both the collar and the separation spring assembly may apply bias forces on the detent member. When the collar is in the spindle engaged position and detent member is engaged with the drive spindle, the detent member may be moved out of the collar recess.

According to a sixteenth example embodiment, the fifteenth example embodiment may be modified such that the collar is configured to be moved relative to the body assembly, by a user, in a direction against the collar spring bias, from the spindle engaged position to a spindle transition position to remove the drive spindle from the chuck. In the spindle transition position, the collar may be positioned such that the detent member aligns with the collar recess to disengage the detent member from the drive spindle and permit the separation bias to move the drive spindle.

According to a seventeenth example embodiment, any of the fifteenth through sixteenth example embodiments may be modified such that the collar is configured to be moved relative to the body assembly in a direction against the collar spring bias, from the spindle disengaged position to a spindle transition position to install the chuck onto the drive spindle. In the spindle transition position, the collar may be positioned such that the detent member aligns with the collar recess to permit the detent member to move radially outward to permit continued entry of the drive spindle into a spindle cavity of the body assembly.

Another example embodiment is an eighteenth example embodiment of another chuck for use with a rotating power driver having a drive spindle. According to the eighteenth example embodiment, the chuck may comprise a plurality of jaws configured to open or close to install or remove a bit. The jaws may be disposed at a forward end of the chuck. The chuck may further comprise a body assembly comprising a spindle cavity to receive the drive spindle at a rearward end of the chuck. The body assembly may be configured to translate rotation of the drive spindle about a center axis of the chuck to the plurality of jaws. The chuck may further comprise a detent member moveable relative to the body assembly. The detent member may be movable to engage with the drive spindle to secure the drive spindle to the chuck and disengage from the drive spindle to permit removal of the drive spindle from the chuck. The chuck may also comprise a collar comprising a collar recess and a collar engaging surface. The collar may be axially movable relative to the body assembly and the detent member into a spindle disengaged position and a spindle engaged position. The chuck may also comprise a collar spring operably coupled to the collar to apply a collar spring bias on the collar, and a separation spring assembly disposed within the spindle cavity and configured to apply a separation bias on the drive spindle when the separation spring assembly is engaged with the drive spindle within the spindle cavity. When the collar is in the spindle disengaged position and the detent member is not engaged with the drive spindle, the detent member may be at least partially disposed within the collar recess and the detent member may extend into the spindle cavity to operate as a stop for the separation spring assembly.

According to a nineteenth example embodiment, the eighteenth example embodiment may be modified such that the collar spring is disposed forward of the collar.

According to a twentieth example embodiment, the nineteenth example embodiment may be modified such that the collar spring is disposed rearward of the collar.

Many modifications and other embodiments of the chucks set forth herein will come to mind to one skilled in the art to which these embodiments pertain having the benefit of the teachings presented in the foregoing descriptions and the associated drawings. Therefore, it is to be understood that the chucks are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A chuck for use with a rotating power tool having a drive spindle, the chuck comprising:
a plurality of jaws configured to open or close to install or remove a bit;
a body assembly comprising a spindle cavity configured to receive the drive spindle, the body assembly also being configured to translate rotation of the drive spindle about a center axis of the chuck to the plurality of jaws to rotate the bit;
a detent member moveable relative to the body assembly, the detent member being movable to engage with the drive spindle to secure the drive spindle to the chuck and disengage from the drive spindle to permit removal of the drive spindle from the chuck;
a collar comprising a collar recess and a collar engaging surface, the collar being axially movable relative to the body assembly and the detent member into a spindle disengaged position and a spindle engaged position;
a collar spring operably coupled to the collar to apply a collar spring bias on the collar; and
a separation spring assembly disposed within the spindle cavity and configured to apply a separation bias on the drive spindle when the separation spring assembly is engaged with the drive spindle within the spindle cavity;
wherein, when the collar is in the spindle disengaged position and the detent member is not engaged with the drive spindle, the detent member is at least partially disposed within the collar recess and both the collar and the separation spring assembly apply bias forces on the detent member;
wherein, when the collar is in the spindle engaged position and detent member is engaged with the drive spindle, the detent member is moved out of the collar recess and onto the collar engaging surface to inhibit radial movement of the detent member.

2. The chuck of claim 1, wherein the collar is configured to be moved relative to the body assembly, by a user, in a direction against the collar spring bias on the collar, from the spindle engaged position to a spindle transition position to remove the drive spindle from the chuck;
wherein, in the spindle transition position, the collar is positioned such that the detent member aligns with the collar recess to disengage the detent member from the drive spindle and permit the separation bias to force the drive spindle towards an opening of the spindle cavity.

3. The chuck of claim 2, wherein the body assembly comprises a collar stop surface, wherein the collar stop surface contacts the collar to stop movement of the collar beyond the spindle transition position.

4. The chuck of claim 1, wherein the collar is configured to be moved relative to the body assembly in a direction against the collar spring bias, from the spindle disengaged position to a spindle transition position to install the chuck onto the drive spindle;
wherein, in the spindle transition position, the collar is positioned such that the detent member aligns with the collar recess to permit the detent member to move radially out of the spindle cavity and permit continued entry of the drive spindle into the spindle cavity.

5. The chuck of claim 1, wherein the collar spring bias urges the collar in an opposite direction than the separation spring assembly urges the drive spindle.

6. The chuck of claim 1 further comprising a detent spring disposed in the collar recess and configured to urge the detent member into contact with the separation spring assembly or the drive spindle.

7. The chuck of claim 1, wherein the body assembly comprises a spindle pin disposed within the spindle cavity and configured to operably couple with the drive spindle;
wherein the separation spring assembly comprises a separation spring and a separation ring with a ring opening;
wherein the spindle pin is disposed within the ring opening.

8. The chuck of claim 7, wherein the separation spring is a coil spring that coils around the spindle pin.

9. The chuck of claim 7, wherein the spindle pin comprises a stop ridge configured to stop movement of the separation ring towards an opening of the spindle cavity due to the separation bias.

10. The chuck of claim 7, wherein the separation ring comprises a ring ridge configured to contact the detent member to stop movement of the separation ring towards an opening of the spindle cavity due to the separation bias.

11. The chuck of claim 1 further comprising a snap ring coupled to the body assembly;
wherein, when the collar is in the spindle engaged position and detent member is engaged with the drive spindle, movement of the collar in a direction towards an opening of the spindle cavity due to urging by the collar spring is stopped by the snap ring to maintain the collar in the spindle engaged position.

12. The chuck of claim 1, wherein the body assembly comprises a detent passageway in a sidewall of the spindle cavity;
wherein the detent member is disposed within the detent passageway.

13. The chuck of claim 1, wherein the collar comprises a sidewall of the collar recess;
wherein the sidewall comprises a chamfer surface;
wherein the detent member is urged against the chamfer surface of the sidewall when the collar is in the spindle disengaged position.

14. The chuck of claim 13, wherein the detent member is a ball;
wherein the chamfer surface of the sidewall operates as a ramp to move the ball out of the collar recess and onto the collar engaging surface when the collar moves from the spindle disengaged position to the spindle engaged position.

15. A chuck for use with a rotating power tool having a drive spindle, the chuck comprising:
a plurality of jaws configured to open or close to install or remove a bit;
a body assembly being configured to translate rotation of the drive spindle about a center axis of the chuck to the plurality of jaws;
a detent member movable to engage with the drive spindle to secure the drive spindle to the chuck and disengage from the drive spindle to permit removal of the drive spindle from the chuck;
a collar comprising a collar recess, the collar being axially movable relative to the body assembly into a spindle disengaged position and a spindle engaged position;
a collar spring operably coupled to the collar to apply a collar spring bias on the collar; and
a separation spring assembly operably coupled to the body assembly and configured to apply a separation bias on the drive spindle when the separation spring assembly is engaged with the drive spindle;
wherein, when the collar is in the spindle disengaged position and the detent member is not engaged with the drive spindle, the detent member is at least partially disposed within the collar recess and both the collar and the separation spring assembly apply bias forces on the detent member;
wherein, when the collar is in the spindle engaged position and detent member is engaged with the drive spindle, the detent member is moved out of the collar recess.

16. The chuck of claim 15, wherein the collar is configured to be moved relative to the body assembly, by a user, in a direction against the collar spring bias, from the spindle engaged position to a spindle transition position to remove the drive spindle from the chuck;
wherein, in the spindle transition position, the collar is positioned such that the detent member aligns with the collar recess to disengage the detent member from the drive spindle and permit the separation bias to move the drive spindle.

17. The chuck of claim 15, wherein the collar is configured to be moved relative to the body assembly in a direction against the collar spring bias, from the spindle disengaged position to a spindle transition position to install the chuck onto the drive spindle;
wherein, in the spindle transition position, the collar is positioned such that the detent member aligns with the collar recess to permit the detent member to move radially outward to permit continued entry of the drive spindle into a spindle cavity of the body assembly.

18. A chuck for use with a rotating power driver having a drive spindle, the chuck comprising:
a plurality of jaws configured to open or close to install or remove a bit, the jaws being disposed at a forward end of the chuck;
a body assembly comprising a spindle cavity to receive the drive spindle at a rearward end of the chuck, the body assembly being configured to translate rotation of the drive spindle about a center axis of the chuck to the plurality of jaws;
a detent member moveable relative to the body assembly, the detent member being movable to engage with the drive spindle to secure the drive spindle to the chuck and disengage from the drive spindle to permit removal of the drive spindle from the chuck;
a collar comprising a collar recess and a collar engaging surface, the collar being axially movable relative to the body assembly and the detent member into a spindle disengaged position and a spindle engaged position;
a collar spring operably coupled to the collar to apply a collar spring bias on the collar; and
a separation spring assembly disposed within the spindle cavity and configured to apply a separation bias on the drive spindle when the separation spring assembly is engaged with the drive spindle within the spindle cavity;
wherein, when the collar is in the spindle disengaged position and the detent member is not engaged with the drive spindle, the detent member is at least partially disposed within the collar recess and the detent member extends into the spindle cavity to operate as a stop for the separation spring assembly.

19. The chuck of claim 18, wherein the collar spring is disposed forward of the collar.

20. The chuck of claim 18, wherein the collar spring is disposed rearward of the collar.
